(19) United States
(12) Patent Application Publication
(10) Pub. No.: US 2026/0120574 A1
(43) Pub. Date: Apr. 30, 2026

(54) SYSTEM AND METHOD FOR MANAGING A RIDING GROUP OF VEHICLES

(71) Applicant: BOMBARDIER RECREATIONAL PRODUCTS INC., Valcourt (CA)

(72) Inventors: Francois ST-LAURENT, Sherbrooke (CA); Mathieu ROY PARE, Candiac (CA); Curtis HORTON, Sherbrooke (CA)

(21) Appl. No.: 19/374,316

(22) Filed: Oct. 30, 2025

Related U.S. Application Data
(60) Provisional application No. 63/714,510, filed on Oct. 31, 2024.

(51) Int. Cl. G08G 1/00; B60W 30/16; B60W 40/08; B60W 50/14; G06V 10/82; G06V 20/58

(52) U.S. Cl. CPC G08G 1/22; B60W 30/16; B60W 40/08; B60W 50/14; G06V 10/82; G06V 20/58; B60W 2040/089; B60W 2050/146; B60W 2420/403; B60W 2540/21; B60W 2554/80; B60W 2556/65; G06V 2201/08

(57) ABSTRACT

A system for managing a riding group having a plurality of vehicles. Each vehicle of the riding group comprises a processing module configured to manage group fracturing and group reforming and to provisionally populate at least one new group created by a user based on predetermined factors, allowing users to accept or reject suggested members and add further users.

### CROSS-REFERENCE

The present application claims priority to U.S. Provisional Patent Application No. 63/714,510, filed Oct. 31, 2024, titled “SYSTEM AND METHOD FOR MANAGING A RIDING GROUP OF VEHICLES”, the entire contents of which are incorporated herein by reference.

### TECHNICAL FIELD

The present technology relates to riding groups of vehicles, and in particular to systems and methods for managing a riding group of vehicles.

### BACKGROUND

Recreational riding activities, particularly those involving riding groups, have gained popularity in recent times. During these activities, users often desire to access information related to their group members for enhanced collaboration and coordination. However, privacy concerns remain a significant issue. Users may not wish to share their information with everyone or have their interface space cluttered with data from non-group members or those not currently riding with them.

Furthermore, various unforeseen events can occur during a ride. Examples of such events comprise a user leaving or joining a group, encountering obstacles or other vehicles, or experiencing technical issues.

The prior art addresses some aspects of these problems by providing mechanisms for users to control the visibility of their information and to communicate with their group members. For instance, social media platforms allow users to create groups and restrict access to certain information based on membership. Similarly, messaging applications enable real-time communication between group members. However, these solutions do not solve all these issues.

Given the above-mentioned challenges, it is therefore an objective of the present technology to overcome at least partially the disadvantages of the prior art.

### SUMMARY

The present technology has been designed to overcome at least some drawbacks present in prior art solutions.

According to an aspect, the present technology relates to a system for managing a riding group comprising a plurality of vehicles riding together, the system comprising:
one processing module associated with each vehicle of the riding group,
one set of sensors integrated into each vehicle of the riding group; each set of sensors being configured to sense an environment surrounding a corresponding vehicle of the riding group; and
one communication module integrated into each vehicle of the riding group and configured to enable the processing modules to communicate with one another directly or via at least one server,
each of the processing modules being configured to:
   manage group fracturing in response to a given vehicle of the plurality of vehicles exiting the riding group by:
   identifying members of the riding group; and
   removing a given vehicle from the riding group in response to a predetermined condition being met.

According to another aspect, the present technology relates to a system for managing a removal of a vehicle from a riding group comprising a plurality of vehicles riding together, the system comprising:
one processing module associated with each vehicle of the riding group,
one set of sensors integrated into each vehicle of the riding group; each set of sensors being configured to sense an environment surrounding a corresponding vehicle of the riding group; and
one communication module integrated into each vehicle of the riding group and configured to enable the processing modules to communicate with one another directly or via at least one server,
each of the processing modules being configured to:
   manage group fracturing in response to a given vehicle of the plurality of vehicles exiting the riding group by:
   identifying members of the riding group; and
   removing a given vehicle from the riding group in response to a predetermined condition being met.

According to another aspect, the present technology relates to a method for managing a riding group comprising a plurality of vehicles riding together, each vehicle of the riding group being associated with one processing module, and each vehicle of the riding group comprising a set of sensors, and a communication module, the method comprising:
managing group fracturing in response to a given vehicle of the plurality of vehicles exiting the riding group by:
identifying members of the riding group; and
removing a given vehicle from the riding group in response to a predetermined condition being met.

According to another aspect, the present technology relates to a system for managing a riding group comprising a plurality of vehicles riding together, the system comprising:
one processing module associated with each vehicle of the riding group;
one set of sensors integrated into each vehicle of the riding group and each set of sensors being configured to sense an environment surrounding a corresponding vehicle of the riding group; and
one communication module integrated into each vehicle of the riding group and configured to enable the processing modules to communicate with one another directly or via at least one server; and
wherein the processing module is configured to:
manage group forming in response to a rider joining or rejoining the riding group by: identifying members of the riding group;
identifying a new vehicle that is not a member of the riding group;
determining whether the new vehicle is allowed to join or rejoin the riding group based on at least one predetermined criterion;
adding the new vehicle to the riding group in response to the new vehicle meeting the at least one predetermined criterion; and
notifying at least one vehicle of the riding group of the new vehicle being added to the riding group.

According to another aspect, the present technology relates to a system for managing an addition of a vehicle to a riding group comprising a plurality of vehicles riding together, the system comprising:
one processing module associated with each vehicle of the riding group;
one set of sensors integrated into each vehicle of the riding group and each set of sensors being configured to sense an environment surrounding a corresponding vehicle of the riding group; and
one communication module integrated into each vehicle of the riding group and configured to enable the processing modules to communicate with one another directly or via at least one server; and
wherein the processing module is configured to:
manage group forming in response to a rider joining or rejoining the riding group by:
identifying members of the riding group;
identifying a new vehicle that is not a member of the riding group;
determining whether the new vehicle is allowed to join or rejoin the riding group based on at least one predetermined criterion;
adding the new vehicle to the riding group in response to the new vehicle meeting the at least one predetermined criterion; and
notifying at least one vehicle of the riding group of the new vehicle being added to the riding group.

According to another aspect, the present technology relates to a method for managing a riding group comprising a plurality of vehicles riding together, each vehicle of the riding group being associated with a processing module, each vehicle of the riding group comprising a set of sensors, and a communication module, the method comprising:
managing group forming in response to a rider joining or rejoining the riding group by:
   identifying members of the riding group;
   identifying a new vehicle that is not a member of the riding group;
   determining whether the new vehicle is allowed to join or rejoin the riding group based on at least one predetermined criterion;
   adding the new vehicle to the riding group in response to the new vehicle meeting the at least one predetermined criterion; and
   notifying at least one vehicle of the riding group of the new vehicle being added to the riding group.

According to another aspect, the present technology relates to a A method for managing membership of a riding group comprising a plurality of vehicles riding together, each vehicle of the riding group being associated with a processing module, each vehicle of the riding group comprising a set of sensors and a communication module, the method comprising managing group membership by:
identifying members of the riding group;
monitoring at least one removal condition associated with a given vehicle of the riding group;
removing the given vehicle from the riding group in response to the at least one removal condition being met;
identifying a new vehicle that is not a member of the riding group;
determining whether the new vehicle is allowed to join or rejoin the riding group based on at least one predetermined criterion;
adding the new vehicle to the riding group in response to the new vehicle meeting the at least one predetermined criterion; and
notifying at least one vehicle of the riding group of changes in group membership.

According to another aspect, the present technology relates to a computer product program for managing a riding group which, when executed by at least one processing unit, executes the method according to the present technology.

According to another aspect, the present technology relates to a computer product program for managing membership of a riding group which, when executed by at least one processing unit, executes the method according to the present technology.

According to another aspect, the present technology relates to a non-volatile memory comprising at least one computer program product according to the present technology.

Before providing below a detailed review of embodiments of the technology, some optional characteristics that may be used in association or alternatively will be listed hereinafter:

According to an example, the predetermined condition comprises at least one of:
receiving, by at least one of the processing modules, a notification from the given vehicle, the notification being generated by the processing module of the given vehicle in response to a command of a driver of the given vehicle;
losing, by at least one of the processing modules, a direct connection to the given vehicle in response to the given vehicle being overtaken by another vehicle outside of the riding group; or
detecting the given vehicle at a distance from at least one of the vehicles of the riding group greater than a predetermined threshold.

According to an example, each of the processing modules is configured to:
monitor at least one of:
   distances between each vehicle of the riding group using sensor data from a corresponding set of sensors; or
   distances between each vehicle in the riding group with respect to an average position of the riding group; and
display a warning message to a driver of the given vehicle in response to the distance of the given vehicle to a vehicle of the riding group being greater than a first threshold, the first threshold being lower than the predetermined threshold.

According to an example, the monitored distances between each vehicle in the riding group with respect to the average position of the riding group are monitored along at least one of a riding path or perpendicular to a riding path.

According to an example, each of the processing modules is configured to temporarily split the riding group in response to the given vehicle being disposed at a distance between the first threshold and the predetermined threshold.

According to an example, a command from a driver of a given vehicle is at least one of a push of a button or a vocal command, a processing module of the given vehicle is configured to request confirmation from the driver that the driver wants to leave the riding group, and the confirmation from the driver serves as the command indicating the driver's intent to leave the riding group.

According to an example, each of the processing modules is configured to temporarily split the riding group in response to the given vehicle being disposed at a distance between the first threshold and the predetermined threshold.

According to an example, the command of the driver of the given vehicle is at least one of a push of a button or a vocal command.

According to an example, the processing module of the given vehicle is configured request from the driver of the given vehicle a confirmation that the driver of the given vehicle wants to leave the riding group.

According to an example, the command of the driver of the given vehicle is the confirmation that the driver of the given vehicle wants to leave the riding group.

According to an example, each of the processing modules is configured to display warnings to the vehicles in the riding group in response to the removal of the given vehicle from the riding group.

According to an example, each of the sets of sensors is configured to detect another vehicle outside of the riding group.

According to an example, each of the processing modules is configured to generate a majority sub-group and a minority sub-group in response to the detection of another vehicle being outside the riding group and taking a position between two vehicles of the riding group, the majority sub-group comprising a number of vehicles of the riding group higher than the number of vehicles of the riding group comprised by the minority sub-group, the majority sub-group and the minority sub-group being on opposite sides of the another vehicle.

According to an example, each of the processing modules is configured to generate a majority sub-group and a minority sub-group in response to the detection of another vehicle not being part of the riding group and taking a position between two vehicles of the riding group, the majority sub-group comprising a number of vehicles of the riding group higher than the number of vehicles of the riding group comprised by the minority sub-group, the majority sub-group and the minority sub-group being on opposite sides of the another vehicle.

According to an example, each of the communication modules enables real-time exchange of information between vehicles of the riding group, comprising alerts and status updates.

According to an example, each of the sets of sensors comprises a perception-based sensor.

According to an example, each of the processing modules is configured to use a perception-based sensor to identify the vehicles of the riding group.

According to an example, each of the sets of sensors comprises a perception-based sensor, and each of the processing modules is configured to use a pre-trained neural network in cooperation with the perception-based sensor to identify the vehicles of the riding group.

According to an example, each processing module is configured to use a pre-trained neural network in cooperation with the perception-based sensor to identify the vehicles of the riding group.

According to an example, each of the processing modules comprises a display device configured to provide at least one of information, notification, or warning to one or more users of each vehicle of the riding group and to receive user input.

According to an example, the predetermined condition comprises at least one of:
receiving a notification from the given vehicle, the notification being generated in response to a command of driver of the given vehicle;
losing a direct connection to the given vehicle in response to the given vehicle being overtaken by another vehicle outside of the riding group; or
detecting the given vehicle at a distance from at least one of the vehicles of the riding group greater than a predetermined threshold.

According to an example, the present technology comprises:
monitoring at least one of:
   distances between each vehicle of the riding group using sensor data from a corresponding set of sensors; or
   distances between each vehicle in the riding group with respect to an average position of the riding group; and
displaying a warning message to the driver of the given vehicle in response to the distance of the given vehicle to a vehicle of the riding group being greater than a first threshold, the first threshold being lower than the predetermined threshold.

According to an example, the present technology comprises splitting the riding group in response to the given vehicle being disposed at a distance between the first threshold and the predetermined threshold.

According to an example, the present technology comprises requesting from the driver of the given vehicle a confirmation that the driver of the given vehicle wants to leave the riding group.

According to an example, the present technology comprises displaying warnings to the vehicles in the riding group in response to the removal of the given vehicle from the riding group.

According to an example, the present technology comprises detecting another vehicle outside of the riding group.

According to an example, the present technology further generating a majority sub-group and a minority sub-group in response to the detection of another vehicle not being part of the riding group and taking a position between two vehicles of the riding group, the majority sub-group comprising a number of vehicles of the riding group higher than the number of vehicles of the riding group comprised by the minority sub-group, the majority sub-group and the minority sub-group being on opposite sides of the another vehicle.

According to an example, the present technology comprises generating a majority sub-group and a minority sub-group in response to the detection of another vehicle not being part of the riding group and taking a position between two vehicles of the riding group, the majority sub-group comprising a number of vehicles of the riding group higher than the number of vehicles of the riding group comprised by the minority sub-group, the majority sub-group and the minority sub-group being on opposite sides of the another vehicle.

According to an example, identifying vehicles of the riding group comprises using the perception-based sensor in coordination with a pre-trained neural network.

According to an example, using a perception-based sensor to identify the vehicles of the riding group comprises using a pre-trained neural network.

According to an example, each of the sets of sensors comprises a perception-based sensor, and each of the processing modules is configured to use a perception-based sensor and a pre-trained neural network in cooperation with a perception-based sensor to identify the vehicles of the riding group and the new vehicle

According to an example, each of the processing modules comprises a display device.

According to an example, the present technology comprises providing at least one of information, notification, or warning to one or more users of each vehicle of the riding group and to receive user input.

According to an example, each of the processing modules is configured to use a pre-trained neural network in cooperation with a perception-based sensor to identify the vehicles of the riding group.

According to an example, each of the processing modules is configured to use a perception-based sensor to identify the new vehicle.

According to an example, each of the processing modules is configured to use a pre-trained neural network in cooperation with a perception-based sensor to identify the new vehicle.

According to an example, each of the processing modules is configured to identify the new vehicle in response to the new vehicle entering a predetermined range of the riding group, the new vehicle being at a distance from a processing module of a vehicle of the riding group smaller than a predetermined distance.

According to an example, each of the processing modules is configured to continuously scan surroundings for identifying the new vehicle.

According to an example, the new vehicle comprises a processing module configured to continuously scan surroundings for identifying the riding group.

According to an example, each of the processing modules is configured to identify the new vehicle in response to the new vehicle being at a distance from a processing module of a vehicle of the riding group smaller than a predetermined distance.

According to an example, each of the processing modules is configured to identify the new vehicle in response to the new vehicle being within a predetermined distance for at least a predetermined amount of time from at least one of the processing modules of at least one of the vehicles of the riding group.

According to an example, in response to identifying the new vehicle, each of the processing modules is configured to verify that at least one of the vehicles of the riding group is not the detected new vehicle.

According to an example, in response to identifying the new vehicle, each of the processing modules is configured to determine if the new vehicle is a former vehicle of the riding group based on the at least one of the received identification number, user profile or vehicle profile.

According to an example, each of the processing modules is configured to receive at least one of an identification number, a user profile, or a vehicle profile from the new vehicle.

According to an example, each of the processing modules is configured to determine if the new vehicle is allowed to join or rejoin the riding group based on the at least one of the received identification number, user profile, or vehicle profile and wherein the processing module is configured to verify that the at least one of the received identification number, user profile, or vehicle profile is registered in at least one of a predetermined list of identification numbers, a predetermined list of user profiles, or a predetermined list of vehicle profiles allowed to participate in the riding group

According to an example, the present technology further comprise, for identifying a new vehicle in relation to a riding group: one or more processing modules configured to continuously scan surroundings to identify a new vehicle; wherein the system is configured to identify the new vehicle in response to the new vehicle entering a predetermined range of the riding group; wherein the new vehicle comprises a processing module, and the system is further configured to scan the surroundings of the processing module of the new vehicle to identify the riding group; and wherein the system is configured to identify the new vehicle in response to the new vehicle being within a predetermined distance for at least a predetermined amount of time from at least one processing module of a vehicle in the riding group.

According to an example, each of the processing modules is configured to determine if the new vehicle is allowed to join or rejoin the riding group based on the at least one of the received identification number, user profile, or vehicle profile.

According to an example, each of the processing modules is configured to determine if the new vehicle is a former vehicle of the riding group based on the at least one of the received identification number, user profile or vehicle profile.

According to an example, each of the processing modules is configured to verify that the at least one of the received identification number, user profile, or vehicle profile is registered in at least one of a predetermined list of identification numbers, a predetermined list of user profiles, or a predetermined list of vehicle profiles allowed to participate in the riding group.

According to an example, each of the processing modules is configured to send at least one of an identification number, a user profile, a group profile, or a vehicle profile to the new vehicle to allow a driver of the new vehicle to decide to join or rejoin the riding group.

According to an example, the new vehicle comprises a processing module configured to verify that at least one of the received identification number, the user profile, the received group profile or the received vehicle profile is registered in at least one of a predetermined list of identification numbers, a predetermined list of user profiles, or a predetermined list of vehicle profiles.

According to an example, the at least one predetermined criterion comprises at least one of:
an identification number associated with the new vehicle being registered in a predetermined list of identification numbers allowed to participate in the riding group;
a user profile associated with the new vehicle being registered in a predetermined list of user profiles allowed to participate in the riding group;
a group profile associated with the new vehicle being registered in a predetermined list of group profiles allowed to participate in the riding group; or
a vehicle profile associated with the new vehicle being registered in a predetermined list of vehicle profiles allowed to participate in the riding group.

According to an example, in response to adding the new vehicle to the riding group, each of the processing module is configured to add the position of the new vehicle in the riding group.

According to an example, each of the processing module is configured to add the new vehicle to the riding group in response to a validation by a driver of the new vehicle of a request to join or rejoin the riding group.

According to an example, to identify a new vehicle, each of the processing module is configured to at least one of:
detect the new vehicle using the set of sensors; or
receive a request for joining or rejoining the riding group from the new vehicle.

According to an example, each of the processing modules is configured to send a request to join or rejoin the riding group to a driver of the new vehicle in response to the identification of the new vehicle.

According to an example, each of the processing modules is configured to identify the new vehicle in response to the new vehicle being within a predetermined range of the riding group.

According to an example, each of the processing modules is configured to use at least one of continuous scanning or notification signals to identify the new vehicle.

According to an example, each of the communication modules enables real-time exchange of information between vehicles, comprising alerts and status updates.

According to an example, the present technology comprises using the perception-based sensor to identify the vehicles of the riding group.

According to an example, the present technology comprises using a pre-trained neural network in cooperation with a perception-based sensor to identify the vehicles of the riding group.

According to an example, the present technology comprises using the perception-based sensor to identify the new vehicle.

According to an example, the present technology comprises using a pre-trained neural network in cooperation with a perception-based sensor to identify the new vehicle.

According to an example, the new vehicle is identified in response to the new vehicle entering a predetermined range of the riding group.

According to an example, the present technology comprises continuously scanning surroundings, for identifying the new vehicle.

According to an example, the new vehicle comprises a processing module.

According to an example, the present technology comprises continuously scanning surroundings of the processing module of the new vehicle for identifying the riding group.

According to an example, the new vehicle is identified in response to the new vehicle being within a predetermined distance for at least a predetermined amount of time from at least one of the processing modules of the vehicles of the riding group.

According to an example, the new vehicle is identified in response to the new vehicle spending a number of seconds higher than a predetermined number of seconds at a distance from at least one of the processing modules of at least one of the vehicles of the riding group smaller than a predetermined distance.

According to an example, the present technology comprises a step of verifying that at least one of the vehicles of the riding group is not the detected new vehicle, in response to the identification of the new vehicle.

According to an example, the present technology comprises, after identifying a new vehicle, receiving at least one of an identification number, a user profile, a group profile, or a vehicle profile from the new vehicle.

According to an example, the present technology comprises determining if the new vehicle is allowed to join or rejoin the riding group based on at least one of the received identification number, the received user profile, the received group profile, or the received vehicle profile.

According to an example, the present technology comprises, after identifying the new vehicle, determining if the new vehicle is a former vehicle of the riding group using at least one of the received identification number, the received user profile, the received group profile, or the received vehicle profile.

According to an example, the present technology comprises verifying that at least one of the received identification number or received user profile or received vehicle profile is registered in at least one of a predetermined list of identification numbers or a predetermined list of user profiles or a predetermined list of vehicle profiles, allowed to participate in the riding group.

According to an example, the present technology comprises, after identifying the new vehicle, sending at least one of an identification number, a user profile, a group profile, or a vehicle profile to the new vehicle to allow a driver of the new vehicle to decide to join or rejoin the riding group.

According to an example, the present technology comprises verifying by the processing module of the new vehicle that at least one of the received identification number, the received user profile, the received group profile or the received vehicle profile is registered in at least one of a predetermined list of identification numbers, a predetermined list of user profiles, a predetermined list of group profiles or a predetermined list of vehicle profiles.

According to an example, the at least one predetermined criterion comprises at least one of:
an identification number associated with the new vehicle being registered in a predetermined list of identification numbers allowed to participate in the riding group;
a user profile associated with the new vehicle being registered in a predetermined list of profiles allowed to participate in the riding group;
a group profile associated with the new vehicle being registered in a predetermined list of profiles allowed to participate in the riding group; or
a vehicle profile associated with the new vehicle being registered in a predetermined list of profiles allowed to participate in the riding group.

According to an example, the present technology comprises adding the position of the new vehicle in the riding group in response to adding the new vehicle to the riding group.

According to an example, the present technology comprises adding the new vehicle to the riding group in response to a validation by a driver of the new vehicle of a request to join or rejoin the riding group.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1a is a schematic representation of a system according to the present technology;

FIG. 1b is a schematic representation of a graphical user interface according to the present technology;

FIG. 1c is a schematic representation of a graphical user interface displaying a message according to the present technology;

FIG. 2 is a schematic representation of a riding group;

FIG. 3 is a schematic representation of another riding group;

FIG. 4 is a schematic representation of an organization of user-profiles and vehicle-profiles in a system according to the present technology;

FIG. 5 is a schematic representation of a formation of a riding group;

FIG. 6 is a flowchart representing steps of a method for managing a riding group;

FIG. 7 is a flowchart representing steps of another method for managing a riding group;

FIGS. 8a and 8b are representations of a fracturing situation of a riding group;

FIG. 9 is a flowchart representing steps of another method for managing a riding group;

FIG. 10 is a flowchart representing steps of another method for managing a riding group;

FIGS. 11a and 11b are schematic representations of a regrouping situation of one vehicle with a riding group;

FIG. 12 is a flowchart representing steps involved in a method for detecting potential threats;

FIG. 13 is a flowchart representing steps of a method for managing communication between vehicles of a riding group;

FIG. 14 is a left-side view of an all-terrain vehicle;

FIG. 15 is a left-side view of a side-by-side vehicle;

FIG. 16 is a left-side view of a snowmobile;

FIG. 17 is a top-right elevated view of a three-wheel vehicle;

FIG. 18 is a left view of a motorcycle;

FIG. 19 is a left view of a personal watercraft;

FIG. 20 is a flowchart representing steps of a method for managing membership of a riding group; and

FIG. 21 is a flowchart representing steps of an another method for managing a riding group.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are comprised within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

Unless otherwise specified herein, or unless the context clearly dictates otherwise the term about modifying a numerical quantity means plus or minus ten percent. Unless otherwise specified, or unless the context dictates otherwise, between two numerical values is to be read as between and comprising the two numerical values.

In the present description, some specific details are comprised to provide an understanding of various disclosed implementations. The skilled person in the relevant art, however, will recognize that implementations may be practiced without one or more of these specific details, parts of a method, components, materials, etc. In some instances, well-known methods associated with artificial intelligence, machine learning and/or neural networks, have not been shown or described in detail to avoid unnecessarily obscuring descriptions of the disclosed implementations.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” or “module” is meant to include software (appropriate to a particular hardware context) that is both necessary and sufficient to achieve the specific function(s) being referenced.

In the context of the present specification, the expression “computer usable information storage medium” or “non-volatile memory” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first processing module” and “third processing module” is not intended to imply any particular order, type, chronology, hierarchy or ranking (for example) of/between the processing modules, nor is their use (by itself) intended imply that any “second processing module” must necessarily exist in any given situation. Further, as is discussed herein in other contexts, reference to a “first” element and a “second” element does not preclude the two elements from being the same actual real-world element Thus, for example, in some instances, a “first” server and a “second” server may be the same software and/or hardware, in other cases they may be different software and/or hardware.

In the present description and appended claims “a”, “an”, “one”, or “another” applied to “embodiment”, “example”, or “implementation” is used in the sense that a particular referent feature, structure, or characteristic described in connection with the embodiment, example, or implementation is comprised in at least one embodiment, example, or implementation. Thus, phrases like “in one embodiment”, “in an embodiment”, or “another embodiment” are not necessarily all referring to the same embodiment. Furthermore, the particular features, structures, or characteristics may be combined in any suitable manner in one or more embodiments, examples, or implementations.

As used in this description and the appended claims, the singular forms of articles, such as “a”, “an”, and “the”, may comprise plural referents unless the context mandates otherwise. Unless the context requires otherwise, throughout this description and appended claims, the word “comprise” and variations thereof, such as, “comprises” and “comprising” are to be interpreted in an open, inclusive sense, that is, as “comprising, but not limited to”.

With these fundamentals in place, we will now consider some non-limiting examples to illustrate various implementations of aspects of the present technology.

The increasing popularity of riding group activities has created a demand for efficient communication and safety management systems. The present technology addresses this need by providing methods for managing communication and alerts within riding groups, enabling real-time coordination, and enhancing safety through automated threat detection and alert generation.

In a riding group, a plurality of users with their vehicles are riding together on the same trip. A riding group can comprise any kind of vehicle, such as cars, motorcycles, watercrafts, aircraft, etc. When users are in a riding group, the ability to communicate can be useful to coordinate vehicles or simply to enjoy the activity.

The present technology relates to various aspects in relation to riding groups. According to a broad aspect, the present technology relates to methods and systems to manage a riding group, as well as the communication between the users within a riding group. According to another broad aspect, the present technology relates to methods and systems to enhance road safety.

### System According to the Present Technology

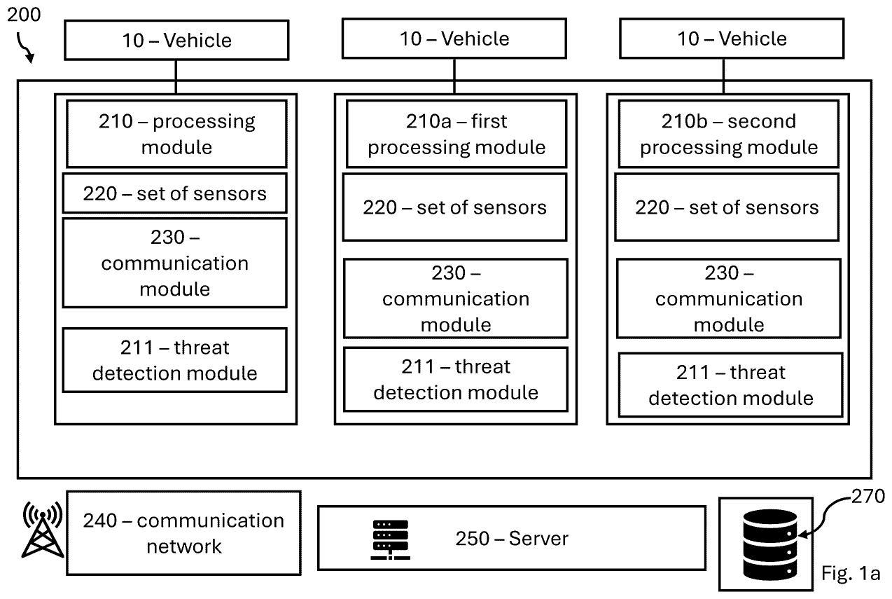

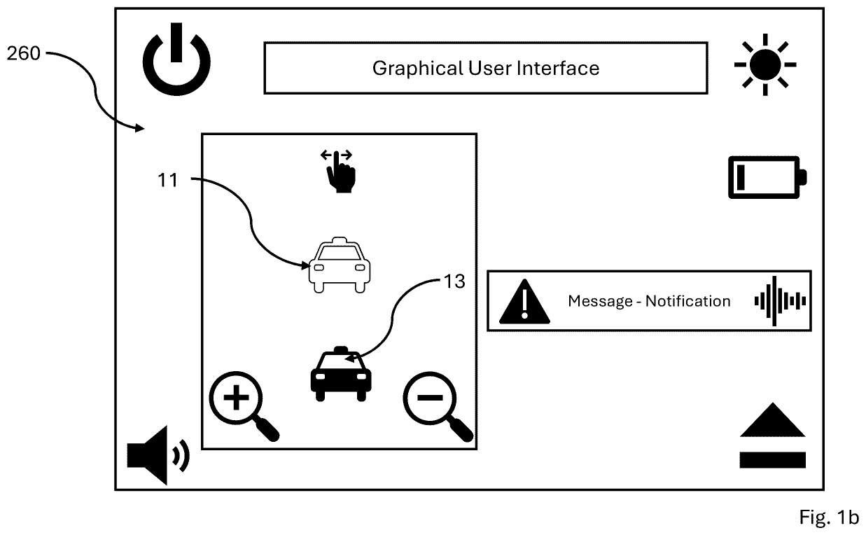

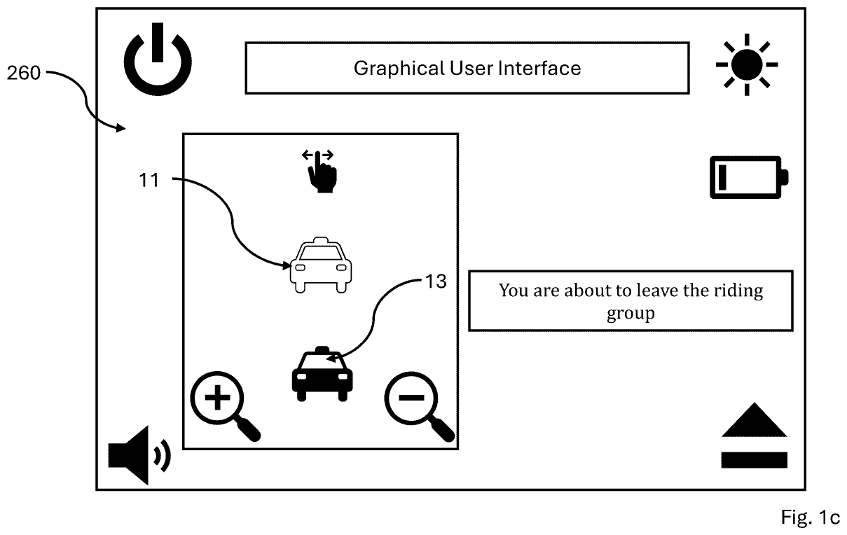

According to an embodiment, and as illustrated by FIG. 1a, the present technology relates to a system 200 for one or more vehicles 10. This system 200 can be configured to enable various functionalities such as enabling communication between vehicles, detecting potential threats, creating riding groups, managing riding groups, creating user profiles, adding friends, loading maps, planning rides, managing participants of a ride, and communicating between friends, members of groups, and participants of riding groups, for example.

According to an embodiment, the system 200 comprises a processing module 210, the processing module 210 being associated with at least one vehicle 10. For example, in a riding group comprising a plurality of vehicles 10, each vehicle may be associated with a distinct processing module 210. The processing module 210 may comprise a display device and input-output ports for transmitting signals wirelessly and enabling the user of the vehicle 10 to interact with the processing module 210 of the system 200.

According to an embodiment, the processing module 210 may be integrated into its associated vehicle 10, e.g., may be implemented by an onboard computer of the vehicle 10. In another embodiment, the processing module 210 may be implemented an off-site computer, like a server 250 for example, in communication with the onboard computer of the vehicle 10 through at least one communication network 240. According to another embodiment, the processing module 210 may be carried on the vehicle by at least one user, e.g., may be implemented by a smartphone of a user. In other embodiments, the processing module 210 may be a combination of the above, e.g., the onboard computer of the vehicle, the server 250 and/or the smartphone of the user may, together, constitute the processing module 210 associated with the vehicle. In this example, the onboard computer of the vehicle and the smartphone of the user may communicate with one another using wired and/or wireless signals (e.g., using RF, WIFI, 5G, Bluetooth, etc.) via input/output ports of the vehicle and of the smartphone, and the server 250 communicates with the smartphone through the communication network 240.

According to an embodiment, the system 200 can be at least partially incorporated into an application designed to be executed on a computing system, such as a smartphone for example.

According to an embodiment, the processing module 210 is at least partially, or even completely, incorporated into an application configured to be executed on a computer of a vehicle and/or on a smartphone or a smartwatch or any suitable device that a user can carry or wear.

According to an embodiment, the processing module 210 can be configured to communicate with external services or devices. For instance, a processing module 210 may interact with GPS navigation systems to provide location-based services to users. According to an embodiment, the processing module 210 may access weather forecasting platforms to offer real-time weather information. According to an embodiment, the processing module 210 may communicate with sensors 220 integrated in a vehicle.

According to an embodiment, the display device can be a touch screen to provide information to one or more users and receive user input. For example, the display device can be the screen of a smartphone or a smartwatch. According to an embodiment, the display device is configured to provide at least one of information, notification, or warning to one or more users of each vehicle of the riding group. Additionally, the display device can be configured to receive user input.

Moreover, and as illustrated by FIG. 1b, the system 200 can comprise a user interface 260 on each vehicle, allowing riders to interact with the system 200, communicate with participants, create and manage riding groups, and customize their preferences and settings. For example, this interface 260 can also be accessible via an application, enabling riders to manage their settings remotely, from their smartphone for example.

Additionally, the user interface may allow users to input their desired destinations and receive personalized ride plans based on real-time traffic and weather conditions, as well as based on the composition of the riding group.

The system's ability to provide real-time traffic and weather information helps users plan their rides more effectively, reducing travel time and improving overall transportation efficiency. This feature is particularly useful in urban areas with heavy traffic congestion and unpredictable weather conditions.

According to an embodiment, input-output ports for transmitting signals wirelessly, such as RF, WIFI or 5G, allow the processing modules 210 associated with each vehicle 10 of the system 200 to communicate with each other directly or via at least one server 250. According to an embodiment, the system 200 comprises a communication module 230 associated with at least one vehicle 10 and its associated processing module 210. For example, in a riding group comprising a plurality of vehicles 10, the system 200 may comprise a plurality of communication modules 230 so that each vehicle 10 of the system 200 is associated with a distinct communication module 230. The communication modules 230 of the system 200 are configured to enable the processing modules 210 of the system to operatively communicate with one another.

For example, in some embodiments, a communication module 230 may be integrated into each vehicle of a riding group. In other embodiments, the communication module 230 may be implemented by input/output ports of the smartphone and/or by the server 250. For instance, the communication module 230 may be configured to employ the communication network 240 using, in some embodiments, long-range or short-range wireless technology such as Bluetooth or Wi-Fi Direct for direct vehicle-to-vehicle communication or using at least one cellular network.

According to an embodiment, the communication modules 230 can be configured to function seamlessly across various vehicle types, comprising cars, motorcycles, bicycles, boats and even planes.

Furthermore, the system 200 may comprise security measures to protect the exchanged data from unauthorized access or interception. For instance, the communication modules 230 could employ encryption techniques or use secure authentication protocols to ensure that only authorized vehicles can participate in the group communication.

According to an embodiment, real-time exchange of information comprises alerts and status updates, allowing vehicles in the riding group to share critical data in real-time. For instance, a leading vehicle may alert following vehicles about upcoming road hazards or traffic congestion, ensuring a safer and more efficient ride for all vehicles in the riding group.

Additionally, the system 200 may incorporate data processing capabilities to analyze the exchanged information and provide valuable insights or recommendations to the riding group. For example, the system 200 could suggest optimal routes based on real-time traffic conditions or alert riders when they are falling behind the group.

According to an embodiment, the processing module 210 is configured to collect and process real-time traffic data. Each processing module 210 can also be configured to obtain real-time weather information. The collected traffic and weather data are then analyzed and combined to generate optimized ride plans for users.

According to an embodiment, the processing modules 210 communicate with one another via the communication modules 230 associated with each vehicle 10 to ensure consistent and accurate data analysis. This collaboration enables the system 200 to provide comprehensive and efficient ride planning solutions.

The system 200 can also comprise a set of sensors 220 integrated into each vehicle or carried by the users, such as distance sensors, GPS sensors, cameras, lidar, and radar. At least some of the sensors of the set of sensors can be incorporated into a smartphone or a smartwatch for example. These sets of sensors can be configured to enable detection of obstacles and threats around each vehicle and as well as to locate each vehicle of the riding group. For example, the set of sensors 220 is configured to sense an environment surrounding a corresponding vehicle of the riding group. According to an embodiment, the leading vehicle of the riding group comprises the set of sensors. According to this embodiment, the leading vehicle is configured to communicate and transmit information to the other vehicles regarding threats or dangers. According to another embodiment, each vehicle of the riding group comprises a set of sensors 220 and is configured to communicate and transmit information to the other vehicles regarding threats or dangers. According to an embodiment, each of the sets of sensors 220 comprises a perception-based sensor.

According to an embodiment, each vehicle 10 of the riding group is associated with a processing module 210 and comprises a set of sensors 220 and a communication module 230. According to FIG. 1, each vehicle of the riding group comprises a group of modules and sensors.

According to an embodiment, each vehicle within a riding group is assigned a specific riding position based on its relative location to other vehicles in the group. The riding positions are used as a basis for generating alerts and notifications that are distributed to the vehicles within the group.

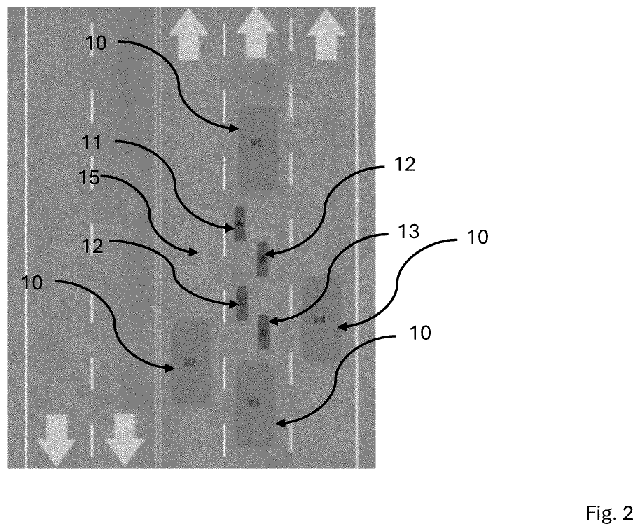

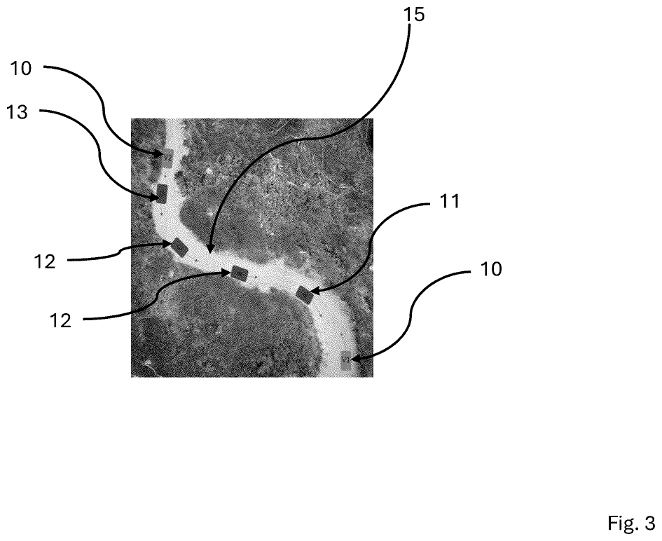

The riding positions, as illustrated by FIGS. 2 and 3, may include:
Leader 11: The vehicle at the front of the group, typically responsible for setting the pace and direction.
Closer 13: The vehicle at the rear of the group, often serving as a safety and providing support to other riders.
Followers 12: Other vehicles within the group that are not in the leader or closer positions.

According to an embodiment, a riding group comprises at least one leader 11, at least one closer 13 and optionally at least one follower 12.

In addition to these basic riding positions, further classifications may be employed depending on the specific formation or configuration of the group. For instance, when riding in staggered formations, the “follower” position may be further classified as “right” or “left” to indicate the vehicle's relative position within the group.

The determination of a vehicle's riding position within the group can be achieved through various means, including:
Using GPS sensors to determine the vehicle's location relative to other vehicles in the group;
Inferring the vehicle's position from sensor information obtained from cameras, radar, lidar or other sensing devices;
Employing V2V (vehicle-to-vehicle) communication and V2X (vehicle-to-everything) communication protocols to exchange data with other vehicles within the group; and
Utilizing local triangulation methods to estimate the vehicle's position based on data received from multiple sources.

In some embodiments, a vehicle may be assigned a riding position based on its proximity to other vehicles in the group. For example:
If no other vehicle of the riding group is detected in front of the vehicle, it is determined to be in the leader position;
If no other vehicle of the riding group is detected behind the vehicle, it is determined to be in the closer position; and
If other vehicles of the riding group are detected in front of and behind the vehicle, it is determined to be in the follower position.

In this embodiment, and as illustrated by FIG. 1b, the user interface 260 of the system 200 comprises an information window or a graphical icon indicating to each user of the vehicles what is the respective riding position of the respective vehicle, and which users occupy other riding positions.

Within the riding group, users can communicate with each other through various methods, comprising text messaging, voice calls, video chat or in-app notifications, for example. This feature allows users to stay connected and coordinate activities. For example, while riding, users can use voice calls. And when the users are not riding they can use text messaging, voice calls, video chat or in-app notifications, for example.

The system 200 can also comprise additional features to enhance the user experience and improve group coordination. For example, it may provide real-time location sharing between vehicles, enabling riders to monitor each other's positions during the ride.

Furthermore, the system 200 can be integrated with external services such as social media platforms, mapping applications, weather forecasting tools, and music streaming platforms to expand its functionality and provide a more comprehensive user experience.

According to an embodiment, the system 200 can be configured for managing alerts within a riding group of multiple vehicles. The system 200 is designed to determine the riding position of each vehicle in the group based on their relative positions, generate and distribute alerts to each vehicle in the group based on their riding positions, and filter out false alerts caused by vehicles in the group.

One feature of the technology involves determining a riding position for each vehicle in the group. This can be accomplished by analyzing the positions of all vehicles in the group relative to one another.

Another feature, discussed in more detailed hereafter, involves generating and distributing alerts to each vehicle in the group based on their riding positions. According to an embodiment, forward proximity alerts, for example, are displayed only on the leader vehicle, while rear proximity alerts are shown on the closer vehicle; side-facing alerts, such as blind spot alerts, can be displayed on all vehicles.

According to an embodiment, the forward proximity alerts can be shared only by the leader vehicle and displayed on all vehicles. A goal of this example is to give group members behind further warning of an issue at the front of the group.

According to an embodiment, the rear proximity alerts could be shared only by the closer vehicle and displayed on all vehicles. A goal of this example is to give group members ahead warning of an issue at the back of the group.

According to another embodiment, all alerts are shared between all vehicles of the riding group.

The present technology can be configured to filter out false alerts caused by other vehicles in the group to avoid unnecessary distractions or false alarms. This can be achieved through a verification step that ensures the reason for the alert is not another vehicle in the group before transmitting it to other vehicles. For instance, when a vehicle detects another vehicle in a blind spot, the system 200 may require a verification step to ensure that the other vehicle is not part of the riding group before transmitting the blind spot alert to other vehicles. For example, if a vehicle is detected in the blind spot of a first vehicle of the riding group, and if this detected vehicle is a vehicle being part of the riding group, then only the first vehicle gets the notification, but if the vehicle detected by the first vehicle is not part of the riding group, then that notification is sent to all vehicles of the riding group.

According to an embodiment, and as described hereafter, each processing module 210 is associated with both a vehicle profile and a user profile. A vehicle profile contains information related to the specific vehicle, such as model, year, mileage, and vehicle identification number. It may also comprise maintenance records and data on accessories connected to the vehicle. A user profile, on the other hand, is a virtual representation of a specific person associated with their personal information, preferences, and vehicle details within the system 200.

According to an embodiment, the processing module 210, using the communication module 230, can be configured to send invitations to a plurality of drivers to be part of a new riding group in response to the creation of a new riding group by a user. According to an embodiment, the processing module 210 can be configured to form the new riding group in response to at least one invited driver being within a predetermined range from another invited driver. For example, the processing module 210 can be configured to provisionally populate new groups created by a user based on factors such as friend lists and geolocation data. Users can accept or reject suggested members and add further friends to the group as desired. Once the group is finalized, all potential group members receive an invitation requesting that they agree to join the group.

One advantage of this system 200 is its ability to facilitate efficient and flexible group creation and management for riding activities while ensuring that only intended members are comprised in the group. This helps ensure safety, coordination, and a more enjoyable riding experience for all participants.

According to an embodiment, the system 200 can be configured to manage a group of vehicles. Each of the processing modules 210 can, for example, be configured to monitor the riding group members and their positions to handle group fracturing and reforming events, as discussed hereafter in more details. When a rider exits the group, the system 200 refreshes the positions in the group and notifies all other group members. If proximity criteria for a given user are not fulfilled, that user is removed from the riding group. The departing vehicle's driver can receive a warning message, and other vehicles in the riding group are notified of the departure. When a rider joins or rejoins the riding group, referred to as group reforming, the system 200 can detect a new vehicle within riding group range using constant scanning or notification signals. The system 200 can determine whether the vehicle is part of the intended riding group and adds it to the riding group if applicable. Positions in the riding group are refreshed, and all parties receive notifications of a user profile joining the riding group.

According to an embodiment, the system 200 can further be configured to monitor distances between each vehicle of the riding group. This is achieved by implementing a distance measurement system that calculates and maintains records of the inter-vehicular distances.

For example, when the distance between a vehicle and the next vehicle exceeds a first warning threshold, a warning message is displayed to the driver of the vehicle.

Furthermore, when the distance between two vehicles surpasses a second threshold, higher than the first threshold, other vehicles in the riding group are notified that the vehicle has left the group. This ensures that the riding group remains cohesive and aware of any changes in its composition.

According to an embodiment, the system 200 is further configured to monitor distances between each vehicle of the riding group regarding an average position of the riding group. This feature enables the system 200 to determine the spatial relationship between individual vehicles and the center of the group, allowing for various applications such as optimizing route planning or monitoring distances for safety.

According to an embodiment, the system 200 is also configured to determine if a new vehicle entering the riding group's range should be added based on pre-determined criteria. These criteria can comprise proximity to the average position of the group, user identification, and group membership status. This feature ensures that only authorized vehicles are added to the riding group, maintaining security and privacy.

According to an embodiment, the system 200 is further configured to notify all parties when a new user profile is added to the riding group. This feature allows for real-time communication between group members, enabling them to be informed of any changes to the group composition. Additionally, it can facilitate coordination and collaboration among group members, enhancing the overall riding experience.

According to an embodiment, the processing module 210 can be configured to generate alerts based on sensor data from each vehicle in the riding group.

Furthermore, the processing module 210 can be configured to distribute these alerts to other processing modules associated with other vehicles in the riding group, for example based on their respective riding positions.

For instance, the leader vehicle might receive alerts about potential threats ahead, while the closer vehicles might receive alerts about imminent collisions from behind. Members of the riding group could also receive alerts about hazards on their respective sides or in their vicinity. By distributing these alerts among the vehicles in the riding group, the system 200 enables a more coordinated response to potential threats and enhances overall safety for all vehicles involved.

According to an embodiment, the processing module 210 can be configured to generate alerts for various vehicle conditions. These alerts can comprise warnings for vehicle problems such as Malfunction Indicator Light (MIL) and Limp Home Status, as well as low fuel notifications. Additionally, side-facing alerts are provided to warn the driver of potential blind spot collisions. According to an embodiment, forward-facing sensors detect imminent collisions and alert the driver accordingly. Furthermore, rear-facing sensors provide warnings for rear collisions to enhance safety.

According to an embodiment, the processing module 210 can be configured to ensure the authenticity of alerts generated by vehicles in the riding group before transmitting them to other vehicles.

For example, the processing module 210 is configured to compare the alert data with real-time vehicle position and status information to determine if the alert is genuine. The processing module 210 helps reduce false alerts that could potentially disrupt the coordinated movement of the riding group.

Moreover, the processing module 210 can be implemented as part of a centralized control unit that oversees the entire riding group's communication and coordination. In this configuration, the central unit can function as an intermediary between vehicles, validating alerts before disseminating them to other members of the group. This approach allows for more efficient management of the verification process while minimizing potential delays or disruptions in the communication flow.

In summary, according to an embodiment, and as illustrated in FIG. 1, the system 200 can comprise:
a first processing module 210a associated with a first vehicle of the riding group;
a second processing module 210b associated with a second vehicle of the riding group;
and wherein:
the first vehicle of the riding group comprises a set of sensors 220 to sense an environment surrounding the first vehicle;
the first processing module 210a is configured to monitor sensor signals from the set of sensors 220 to detect potential threats in the environment surrounding the first vehicle;
upon detecting a potential threat or obstacle, the first processing module 210a is configured to generate an alert signal based on the detected threat or obstacle and to generate a first warning to a first driver of the first vehicle based on the alert signal;
the first processing module 210a is configured to wirelessly send a notification comprising the alert signal to the second processing module 210b; and
the second processing module 210b is configured to generate a second warning to a second driver of the second vehicle based on the notification.

Moreover, according to an embodiment, each of the first 210a and second 210b processing modules can be configured to:
monitor riding group members and their positions, each of these modules being configured to:
   i. manage group fracturing when a rider exits the riding group, comprising:
      1. monitoring distances between each vehicle of the riding group and the next one using sensors data;
      2. displaying warnings to the driver of the departing vehicle and notifying other vehicles in the riding group;
   ii. manage group reforming when a rider joins or rejoins the riding group, comprising:
      1. detecting a new vehicle within riding group range using continuous scanning and/or notification signals;
      2. determining whether the vehicle is part of the riding group and adding it to the riding group if applicable;
      3. refreshing positions in the riding group and notifying all parties of a user profile joining the riding group;
E to provisionally populate new groups created by a user based on factors such as friend lists and geolocation data;
to allow users to accept or reject suggested members and add further friends;
to detect potential threats and to generate alerts among the riding group.

According to an embodiment, the system 200 detects the position and speed of each vehicle and displays a warning when a space between vehicles is below a safe distance threshold. This ensures the safety of all riders in the group.

Furthermore, the system 200 can be configured to optimize overall performance by suggesting a formation to the drivers of the riding group. The optimization may comprise factors such as fuel efficiency, travel time, or rider comfort.

According to an embodiment, the system 200 uses real-time data from sensors on each vehicle to detect position and speed accurately. This allows for quick adjustments in response to changing conditions on the road.

Additionally, the system 200 may use pre-programmed formations or algorithms to suggest optimized riding formations based on specific conditions, such as terrain type or group size. This ensures that the riding formation is always optimal for the given situation.

According to an embodiment, each processing module 210 is configured to support integration with third-party applications or services. This expansion enables the functionality and capabilities of the system 200 to be extended.

In more detail, each processing module 210 may be configured to communicate with external applications or services through standardized interfaces. This communication can occur via application programming interfaces (APIs) or messaging protocols. The integration allows data exchange and functionalities from the third-party applications to be leveraged within the system 200.

For example, the third-party applications can provide additional features such as advanced analytics, machine learning capabilities, or user interface enhancements. This expansion enables the system 200 to adapt to evolving market needs and user requirements.

Moreover, the integration process can be facilitated through the centralized management platform. This platform manages the authentication, authorization, and security of the communication between the processing modules and third-party applications. It also ensures compatibility and version control for seamless integration.

### Vehicles

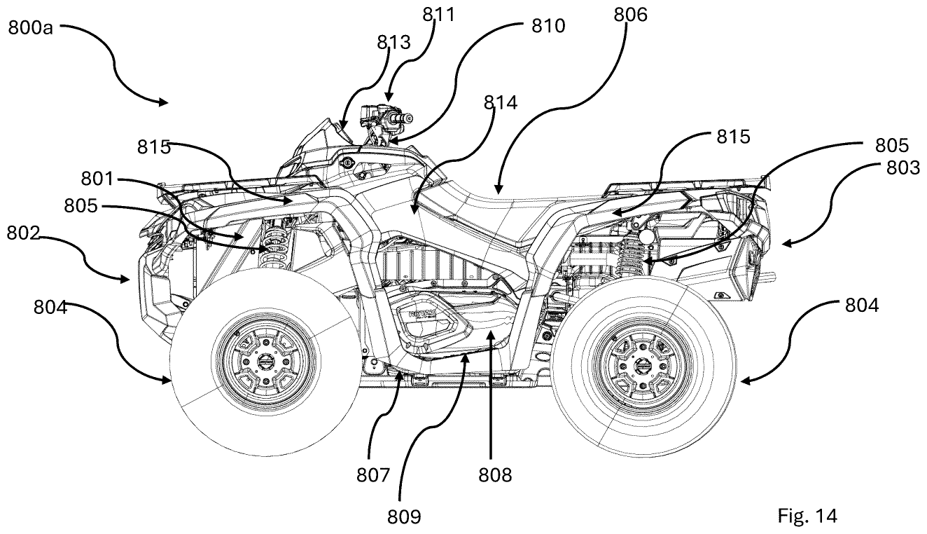

According to an embodiment, and as illustrated by FIGS. 14 to 19, the present technology relates to a vehicle comprising at least one set of sensors 220 and one communication module 230. According to an embodiment, the vehicle comprises the processing module 210. According to another embodiment, the vehicle comprises partially the processing module 210. In this embodiment, the processing module 210 can be split between the vehicle and a server 250, for example.

Referring to FIG. 14, according to an embodiment, the vehicle can be an all-terrain vehicle 800a (hereinafter ATV).

The ATV 800a has a frame 801 having a front end 802 and a rear end 803 defined consistently with a forward travel direction of the ATV 800. The ATV 800a has two front wheels 804 and two rear wheels 804. Each of the four wheels 804 is provided with low-pressure balloon tires adapted for off-road conditions and traversing rugged terrain. It is contemplated that the ATV 800a could have six wheels 804 or only three wheels 804.

The two front wheels 804 are suspended from the frame 801 by left and right front suspension assemblies 805 while the two rear wheels 804 are suspended from the frame 801 by left and right rear suspension assemblies 805.

The ATV 800a further includes a straddle seat 806 connected to the frame 801 for accommodating a driver of the ATV 800a. An internal combustion engine 807 is connected to the frame 801 for powering the ATV 800a. The engine 807 is disposed under the straddle seat 806. It is contemplated that in some embodiment, the engine 807 could be replaced by an electric motor. The wheels 804 are operatively connected to the engine 807 via a continuously variable transmission 808. Driver footrests 809 are provided on either side of the straddle seat 806 and are disposed vertically lower than the straddle seat 806 to support the driver's feet. The footrests 809 are connected to the frame 801. A steering assembly 810 is rotationally connected the frame 801 to enable a driver to steer the ATV 800a. The steering assembly 810 includes a handlebar 811.

A throttle operator (not shown), in the form of a thumb-actuated throttle lever, is mounted to a right side of the handlebar 811. Other types of throttle operators, such as a finger-actuated throttle lever and a twist grip, are also contemplated. Various other buttons and switches are provided on the handlebar 811 to control various functions and features of the ATV 800a. A display cluster 813, including a number of gauges and buttons, is disposed forwardly of the steering assembly 810. According to an embodiment, the display cluster 813 can comprise a screen for showing the user interface 260. It is contemplated that the display cluster 813 could comprise in some embodiments a touch screen.

The ATV 800a also includes fairings 814 extending over the frame 801 of the ATV 800a. A fender 815 is disposed over each wheel 804 to protect the driver and/or passenger from dirt, water and other debris being projected by the rotating wheels 804. The fenders 815 also define a portion of the wheel well in which each one of the wheels 804 rotates and, in the case of the front wheels 804, steers.

The ATV 800a further includes other components such as brakes, a radiator, headlights, and the like. As it is believed that these components would be readily recognized by one of ordinary skill in the art, further explanation and description of these components will not be provided herein.

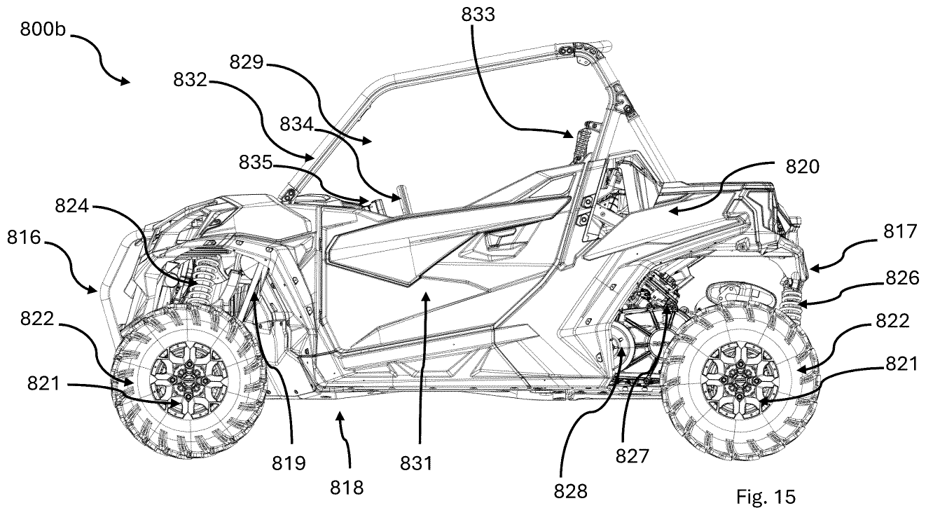

Referring now to FIG. 15, according to an embodiment, the vehicle can be a side-by-side vehicle 800b (hereinafter SSV).

The SSV 800b has a front end 816 and a rear end 817 defined consistently with the forward travel direction of the SSV 800b. The SSV 800b includes a vehicle body 818, to which the other parts of the vehicle 800b are connected. The vehicle body 818 includes a frame 819 and a plurality of body panels 820.

The SSV 800b includes a pair of front wheels 821 and a pair of rear wheels 821. Each one of the wheels 821 has a tire 822. Each front wheel 821 is suspended from a front portion of the frame 819 via a front suspension assembly 824. Each rear wheel 821 is suspended from a rear portion of the frame 819 via a rear suspension assembly 826. Ground engaging members other than wheels 821 are contemplated for the SSV 800b, such as tracks or skis. In addition, although four ground engaging members are illustrated in the Figure, the SSV 800b could include more or less than four ground engaging members. Furthermore, different combinations of ground engaging members, such as tracks used in combination with skis, are contemplated.

The SSV 800b further includes an engine 827 is mounted to a rear portion of the frame 819 of the SSV 800b. The engine 827 is connected to a continuously variable transmission 828, also mounted to the rear portion of the frame 819 of the SSV 800b. The wheels 821 are operatively connected to the engine 827 via the continuously variable transmission 828.

The SSV 800b has a cockpit area 829 disposed generally in the middle portion 830 of the frame 819. The cockpit area 829 has openings on the left and right sides of the SSV 800b through which the riders can enter and exit the SSV 800b. A lateral door 831 is disposed across each opening (only a left lateral door 831 is being shown in FIG. 15). A roll cage 832, connected to the frame 819, is disposed over the cockpit area 829. The cockpit area 829 has a left seat 833 to accommodate a driver of the SSV 800b and a right seat (not shown) to accommodate two passengers (collectively referred to herein as riders). It is contemplated that the SSV 800b could have one or more additional rows of seats. A steering assembly, including a steering wheel 834, is disposed in front of the left seat 833. The steering assembly is operatively connected to the two front wheels 821 to allow steering of the SSV 800b.

A display cluster 835, including a number of gauges and buttons, is disposed forwardly of the steering wheel 834. According to an embodiment, the display cluster 813 can comprise a screen for showing a user interface 260 . . . . It is contemplated that the display cluster 835 could comprise in some embodiments a touch screen. Various other buttons and switches are provided on inside the cockpit area 829 to control various functions and features of the SSV 800b.

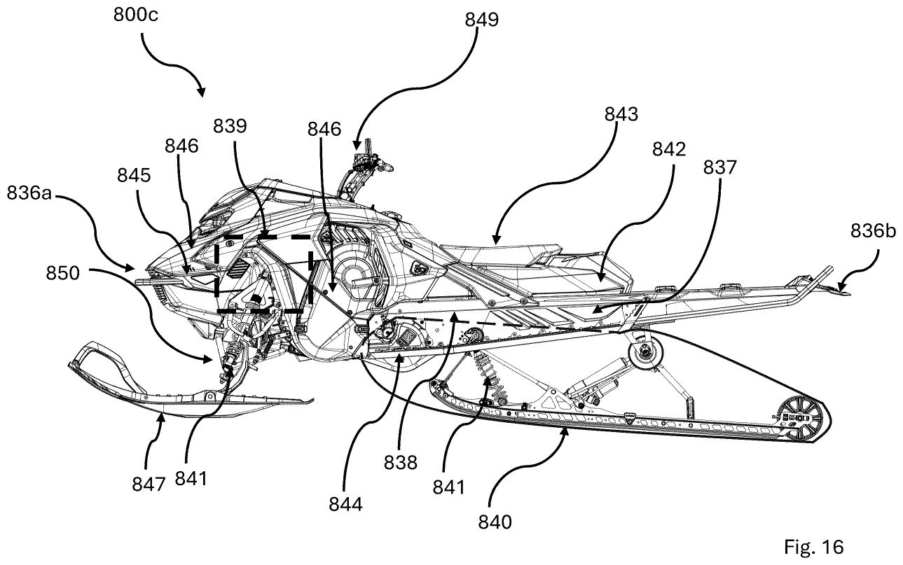

Referring to FIG. 16, according to an embodiment, the vehicle can be a snowmobile 800c.

The snowmobile 800c has a front end 836a and a rear end 836b which are defined consistently with a travel direction of the snowmobile 800c. The snowmobile 800c includes a vehicle body in the form of a frame 837 which includes a tunnel 838. The tunnel 838 is formed from sheet metal parts assembled to form an inverted U-shape when viewed from the front or rear end 836a, 836b.

A motor 839, schematically illustrated, is supported in a motor compartment defined by the frame 837 and provides propulsion of the snowmobile 800c. In the illustrated embodiment, the motor 839 is an internal combustion engine 839, but it is contemplated that it could be, for example, an electric motor.

A rear ground engaging member, in the form of an endless drive track 840 (shown schematically), is positioned generally under the tunnel 838 and is operatively connected to the motor 839 via a drivetrain including a belt transmission system (not shown). The endless drive track 840 is driven to run about a rear suspension assembly 841 connected to the frame 837 for propulsion of the snowmobile 800c.

The fuel tank 842 is disposed on top of the tunnel 838. A straddle seat 843 is positioned on top of the fuel tank 842. As such, the seat 843 is supported by the tunnel 838. The seat 843 is adapted to accommodate the user of the snowmobile 800c. A footrest 844 is positioned on each side of the snowmobile 800c below the seat 843 to accommodate the user's feet. Each of the left and right footrests 844 extends generally laterally outwardly from the sides of the tunnel 838. In the illustrated embodiment, each side portion of the tunnel 838 is bent laterally outwardly at its bottom edge to form the corresponding footrest 844. It is however contemplated that the footrest 844 could be formed separately from and be connected to the tunnel 838.

At the front end 836b of the snowmobile 800c, body panels 845 enclose the motor 839 and other components of the powerpack such as a transmission or air intake system. The body panels 845 include a hood 846 which can be removed/opened to allow access to the motor 839 and other internal components of the snowmobile 800c from the top and the front which may be required, for example, for inspection or maintenance of the motor 839 and/or the powerpack. The body panels 845 also include two side panels 846 extending along the left and right sides of the snowmobile 800c. The side panels 846 are both removably connected to the frame 837 and/or to other body panels 845 and can be removed/opened to access the internal components from the corresponding lateral side.

Front left and front right ground engaging members, in the form of left and right skis 847, are positioned at the front end 836a of the snowmobile 800c and are attached to the frame 837 through front suspension assemblies 841.

A steering system is provided to steer the skis 847. The steering system includes a handlebar 849 disposed forward of the seat 843. The handlebar 849 is operatively connected to ski legs 850. The ski legs 850 are pivotally connected to the skis 847. The handlebar 849 is used to rotate the ski legs 850, and thereby the skis 847, in order to steer the snowmobile 800c.

A throttle operator (not shown), in the form of a thumb-actuated throttle lever, is mounted to a right side of the handlebar 849. Other types of throttle operators, such as a finger-actuated throttle lever and a twist grip 851, are also contemplated. Various other buttons and switches are provided on the handlebar 849 to control various functions and features of the snowmobile 800c. A display cluster, including a number of gauges and buttons, is disposed forwardly of the handlebar 849. According to an embodiment, the display cluster can comprise a screen for showing the user interface 260. It is contemplated that the display cluster could comprise in some embodiments a touch screen.

The snowmobile 800c includes other components such as an exhaust system, an air intake system, and the like. As it is believed that these components would be readily recognized by one of ordinary skill in the art, further explanation and description of these components will not be provided herein.

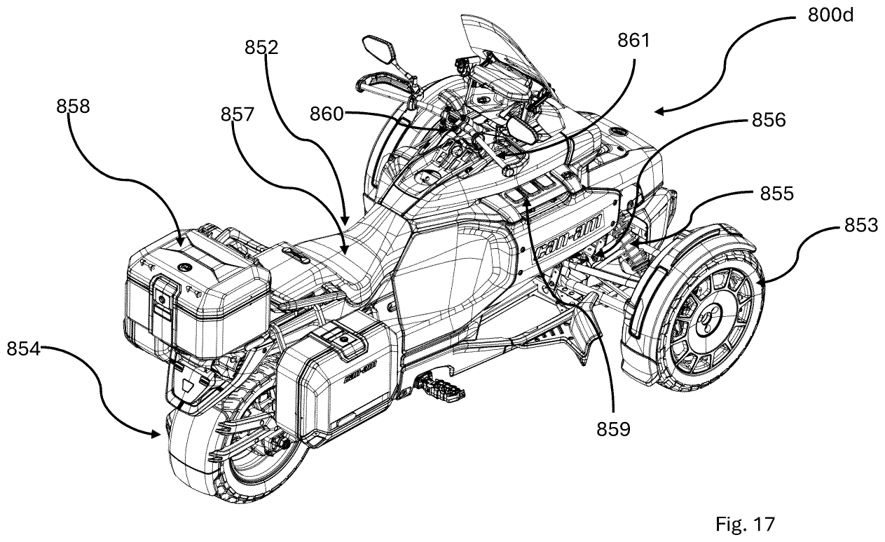

Referring to FIG. 17, according to an embodiment, the vehicle can be a three-wheeled vehicle referred to hereinafter as the vehicle 800d.

The vehicle 800d has a straddle seat 852, steerable left and right front wheels 853 and a single rear wheel 854. The front wheels 853 are equally offset from a central longitudinal axis of the vehicle 800d. The rear wheel 854 is centered between the front wheels 853 aligning with the central longitudinal axis of the vehicle 800d. However, it is contemplated that the vehicle 800d may be configured with two rear wheels and a single front wheel. Each front wheel 853 is supported by a front suspension assembly 855. The rear wheel 854 is supported by a rear suspension assembly (not shown). The front suspension assembly 855 and the rear suspension assembly are secured to a frame 856 of the vehicle 800d.

The straddle seat 852 of the vehicle 800d is connected to and supported by the frame 856. In this embodiment, the straddle seat 852 includes a driver seat portion 857 for accommodating a driver. A vehicle accessory 858, such as a cargo 858, is positioned rearward of and is higher than the driver seat portion 857. It is noted that, in some instances the cargo 858 may be replaced with a passenger seat portion (not depicted) to accommodate a passenger.

A motor 859 is supported by the frame 856. The motor 859 is connected to the rear wheel 854 via a transmission system to drive the rear wheel 854. In the present embodiment, the motor 859 is a four-stoke, inline cylinder, internal combustion engine 859. However, it is contemplated that the motor 859 could have more or fewer cylinders and/or could be any other type of motor, such as a two-stroke, internal combustion engine or an electric motor.

A steering system is provided to steer the front wheels 853. The steering system includes a handlebar 860 disposed forward of the seat 857. The handlebar 860 is operatively connected to front wheels 853. The handlebar 860 is used to rotate the front wheels 853 in order to steer the vehicle 800d.

A throttle operator 861, in the form of a twist grip, is mounted to the handlebar 860. Other types of throttle operators, such as a thumb or finger-actuated throttle lever, are also contemplated. Various other buttons and switches are provided on the handlebar 860 to control various functions and features of the vehicle 800d. A display cluster, including a number of gauges and buttons, is disposed forwardly of the handlebar 860. According to an embodiment, the display cluster can comprise a screen for showing a user interface 260. It is contemplated that the display cluster could comprise in some embodiments a touch screen.

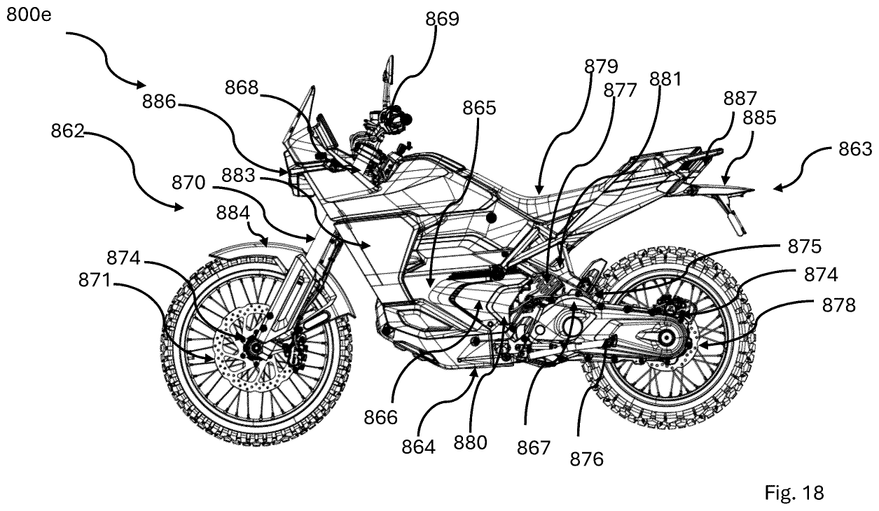

Referring to FIG. 18, according to an embodiment, the vehicle can be a motorcycle 800e.

It is contemplated that the motorcycle 800e illustrated herein could vary by a plurality of vehicle characteristics. These vehicle characteristics could include, but are not limited to, a rider posture configuration (also referred to as a rider position), a motorcycle type, tire type, a wheelbase, a steering arrangement, a weight distribution, a squat ratio, a rake angle, a seat height, and a mechanical trail. The rider posture configuration, or rider position, is the relative spacing and position of a rider's hands (when holding the handlebars), the rider's feet (when positioned on the footrests) and the rider's buttocks (when the rider is seated on a seat of the motorcycle). The steering arrangement could also vary and can be described by a variety of parameters, including but not limited to: a length of front suspension travel, a length of rear suspension travel, a front suspension stiffness, a rear suspension stiffness, a front and/or rear wheel size, rake angle, mechanical trail, triple clamp offset, squat ratio, and wheel base.

The motorcycle 800e, has a front end 862 and a rear end 863 defined consistently with the forward travel direction of the motorcycle 800e.

The motorcycle 800e includes a frame 864. The motorcycle 800e also includes a powerpack 865 for powering the motorcycle 800e. The powerpack 865 includes a battery pack 866 that is supported by the frame 864 and a motor 867 that is electrically connected to the battery pack 866. It is contemplated that in other embodiments, the powerpack 865 could include an internal combustion engine and a fuel tank.

The motorcycle 800e further includes a steering assembly 868 that is operatively connected to a front of the frame 864. The steering assembly 868 includes a handlebar assembly 869 and a front fork assembly 870 operatively connected to the handlebar assembly 869. A front wheel 871 is rotationally connected to a lower end of the front fork assembly 870. The steering assembly 870 can be used by the rider to turn the front wheel 871 to steer the motorcycle 800e.

A twist-grip throttle (not shown) is operatively connected on the right side of the handlebar assembly 869 for controlling motorcycle speed. It is contemplated that the twist-grip throttle could be replaced by a thumb throttle lever or some other type of throttle input device. The twist-grip throttle could be disposed on the left side of the handlebar assembly 869 in some embodiments. The handlebar assembly 869 also includes a brake lever (not shown) on a right side for activating brake assemblies 874. Various other buttons and switches are provided on the handlebar assembly 869 to control various functions and features of the motorcycle 800e. A display cluster is disposed forwardly of the handlebar assembly 869. According to an embodiment, the display cluster can comprise a screen for showing a user interface 260. It is contemplated that the display cluster could comprise in some embodiments a touch screen.

The motorcycle 800e further includes a rear suspension assembly 875 including a swingarm 876 and a shock absorber 877.

A rear wheel 878 is rotationally connected to the swingarm 876. The rear wheel 878 is drivingly connected to the motor 867 via a driving assembly that is disposed on the swingarm 876.

The motorcycle 800e includes a straddle seat 879 disposed longitudinally between the front and rear wheels 871, 878. The straddle seat 879 is connected to frame 864. In the illustrated implementation, the straddle seat 879 is intended to accommodate a single adult-sized rider (i.e. the driver) and a passenger. It is contemplated that that the straddle seat 879 could be longer and/or that the passenger seat portion could be omitted.

A driver footrest 880 is disposed on either side of the motorcycle 800e. The driver footrests 880 are positioned vertically lower than the straddle seat 879 to support the driver's feet. It is contemplated that the footrests 880 could be implemented in various forms other than those illustrated, including but not limited to pegs and footboards. The motorcycle 800e is also provided with passenger footrests 881 disposed rearward of the driver footrest 880 on each side of the motorcycle 800e, for supporting a passenger's feet. It is contemplated that the passenger footrests 881 may be omitted in some embodiments.

A brake pedal (not shown) is next to the right driver footrest 880 for braking the motorcycle 800e. The brake pedal is disposed forward of the right driver footrest 880 such that the driver can actuate the brake pedal with a front portion of the right foot while a rear portion of the right foot remains on the right driver footrest 880.

Each of the front wheel 871 and the rear wheel 878 is provided with a brake assembly 874. The brake assemblies 874 of the wheels 871, 878, along with the brake lever 873 and the brake pedal, form part of a brake system. Each brake assembly 874 is a disc-type brake mounted onto the spindle of the respective wheel 871 or 878. Other types of brakes are contemplated. The brake pedal, as well as the brake lever 873, are operatively connected to the brake assemblies 874 provided on each of the front wheel 871 and the rear wheel 878. The brake system further includes a regenerative braking system (not shown) that uses the electric motor 867 as a generator to charge the battery pack 866 while slowing the motorcycle 800e.

The motorcycle 800e further includes a plurality of fairings 883 that generally form the body of the motorcycle 800e. The fairings 883 may be referred to as body panels. The fairings 883 are connected to the frame 864 and the battery pack 886. The fairings 884 may be additionally and/or alternatively connected to another component of the motorcycle 800e such as a bracket or the rear suspension assembly 875. The fairings 883 at least partially enclose and/or cover and/or protect some internal components of the motorcycle 800e such as the powerpack 865 and the rear suspension assembly 875. In some instances, the fairings 883 can increase aerodynamic performance of the motorcycle 800e, which can positively impact an efficiency of the motorcycle 800e, and can improve ride quality of the motorcycle 800e. Some of the fairings 884 will be described in greater detail below.

The motorcycle 800e also includes a front fender 884 disposed at the front of the motorcycle 800e and extending partially over the front wheel 871. Rearward of the straddle seat 879, the motorcycle 800e also has rear fender panel 885 extending at least partially over the rear wheel 878 and configured to support a motorcycle license plate.

The motorcycle 800e includes a front headlight 886 attached to the front fork assembly 870 and electrically connected to the battery pack 866. The motorcycle 800e also has rear braking and indicator lights 887 electrically connected to the battery pack 866.

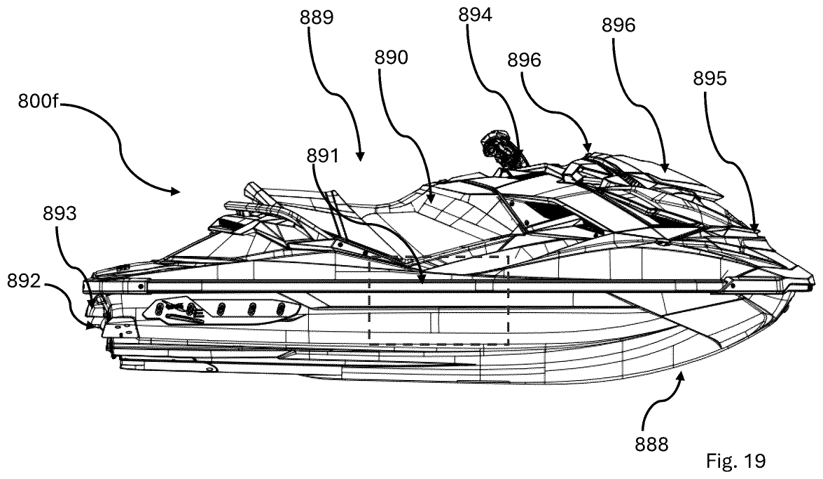

Referring to FIG. 19, according to an embodiment, the vehicle can be a watercraft 800f, for example a personal watercraft.

The watercraft 800f has a hull 888 and a deck 889 mounted to the hull 888. A straddle seat 890 is connected to the deck 889. A motor 891 is connected to the hull 888. A jet propulsion system 892 is connected to the hull 888 and is driven by the motor 891. A reverse gate 893 is connected to the rear of the watercraft 800f near the jet propulsion system 892. A handlebar 894 is pivotally mounted to the deck 889 forward of the straddle seat 890. A front splashguard 895 is mounted to the deck 889 forward of the handlebar 894. A front cowling 896 is connected to the deck 889 longitudinally between the handlebar 894 and the splashguard 895. According to an embodiment, the watercraft 800f can comprise a display cluster located near the handlebar 894. This display cluster can comprise a screen 896 for showing the user interface 260. It is contemplated that the display cluster could, in some embodiments, have a touch screen. The screen 896 is provided forward of the handlebar 894 and is partially housed by the front cowling 896. The screen 896 is configured to show the user interface 260. According to an embodiment, the screen provides information to the driver such as vehicle speed, as well as other information as will be described in greater detail below.

The watercraft 800f may include various additional features depending on its design and purpose. These can include storage compartments, safety equipment, navigation aids, and protective elements such as windshields.

### Creation and Management of a Riding Group

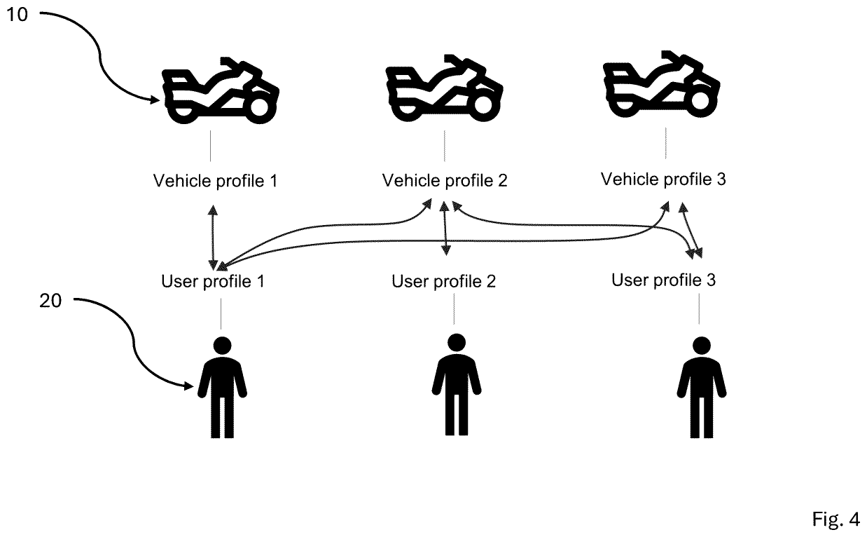

According to an embodiment, and as illustrated by FIGS. 4 to 13, the present technology relates to methods for managing riding groups.

As described hereafter, the creation of a riding group can be at least partially automated.

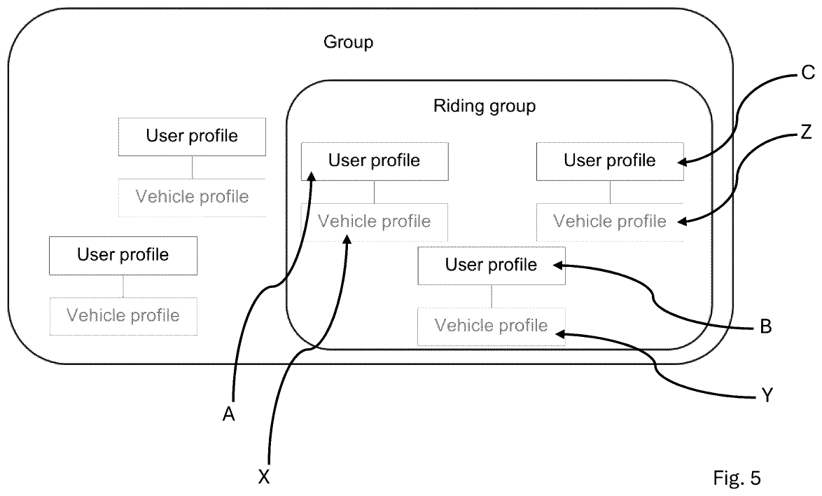

As discussed hereabove, a riding group can be based on user profiles. According to an embodiment, and as illustrated by FIGS. 4 and 5, a user profile is a virtual representation of a specific person associated with their personal information, preferences, and vehicle 10 details within the system 200. Users 20 can create and customize their profiles to include their name, contact information, preferred communication methods, vehicle make and model, and other relevant data. This feature allows users 20 to manage their own information.

Users 20 can add friends to their profile by entering their contact information or connecting through social media platforms. Once added, friends appear in the user's list of contacts and can be easily accessed for communication and group creation. This feature facilitates the formation of riding groups with trusted individuals.

According to an embodiment, groups are collections of user profiles that are associated together for various purposes, such as organizing rides. Users 20 can create new groups, invite friends to join, and manage group composition and settings.

The present technology can comprise a map feature enabling users to plan routes, monitor the progress of rides, and identify potential obstacles or threats. According to an embodiment, users 20 can create itineraries within the system 200, allowing them to share plans with friends and coordinate group activities. Planning a ride involves selecting a start point, setting a destination, and determining the route to be taken. According to an embodiment, the system 200 can be configured to allow users 20 to share their ride plans and itineraries with other users 20 or groups, allowing for coordination and collaboration on rides or events. This feature helps ensure that everyone is aware of the planned route, start and end points, and estimated travel times.

According to an embodiment, a ride refers to an event involving at least one user profile and their associated vehicle profile. Users 20 can create or join rides manually or automatically, and they may form riding groups with other users for coordinated activities during the ride.

According to an embodiment, a riding group is a subset of a group and comprises vehicles and/or drivers that are currently riding together in close physical proximity. It relates to user profiles associated together, where each user profile of the riding group may be participating in a common ride. In an embodiment, the vehicle profiles associated with each user profile are not part of the group, only the user profiles are part of the group.

As illustrated by FIG. 5, three users (User A, User B, and User C) who are part of a larger group of five individuals are currently riding together in close physical proximity. As a result, they form a subset of the larger group known as a ‘riding group’. The vehicle profiles associated with each user profile (Vehicle X for User A, Vehicle Y for User B, and Vehicle Z for User C) are depicted in grey to indicate that while they may be shared or accessible to other members of the riding group, they are not explicitly part of the group itself. In this embodiment, only the user profiles (User A, User B, and User C) are considered part of the riding group.

Users 20 can manage participants of a ride by adding or removing individuals from the riding group, assigning roles such as leader or closer.

For example, when a user 20 creates a new group, the system 200 can automatically populate it with contacts or friends who are within a predetermined distance based on their current geolocation. For example, the processing modules can be configured to:
send invitations to a plurality of drivers to be part of a new riding group in response to the creation of the new riding group by a user using the communication modules; and
form the new riding group in response to at least one invited driver being within a predetermined range from each other each other.

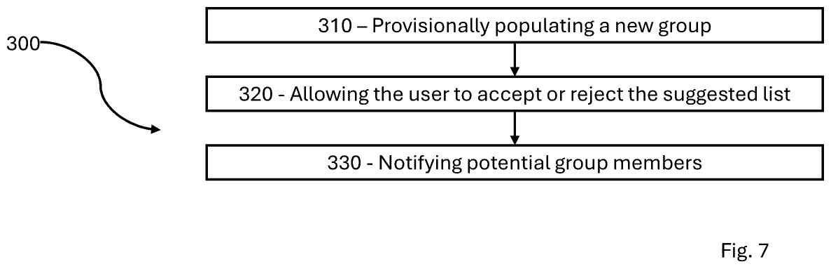

In more detail, and according to an embodiment as illustrated by FIG. 7, upon creation of a new group by a user 20, the system 200 can be configured to provisionally populate 310 the group with friends based on their current geolocation, for example. This means that riders who are physically close to each other can be automatically suggested as potential members of the group. For example, upon initiating group creation, the system 200 prepopulates the list of potential members with friends or users who are within a predetermined distance (e.g., 200 m) from the creator's current location. The user 20 is then allowed 320 to accept or reject these suggestions, giving them control over the composition of their riding group. Indeed, the creator can then review this suggested list and either accept or reject it in whole or in part Additionally, users can add further friends or users to the group at any time. According to an embodiment, each of the processing modules 210 is configured to receive input from the user to create the new riding group. For example, each of the processing modules 210 is configured to generate a suggested lists of drivers by provisionally populating the new riding group created by the user based on predetermined factors. The predetermined factors can comprise a predetermined list of drivers and/or geolocation data.

Once a group has been created and populated with members, the system 200 notifies 330 each potential member that they are invited to join the group. This ensures that all riders are aware of the new group and can choose whether or not to participate. According to an embodiment, once the group is created, each invited member receives an alert requesting their acceptance into the group. The group creator is notified of which members have accepted and declined the invitation, allowing the creator to track participation and ensure that all intended members are included. For example, each of the processing modules 210 is configured to notify the drivers of the plurality drivers that they are invited to join the group. For example, each of the processing modules 210 is configured to enable group functions for each of the drivers accepting the invitation.

According to an embodiment, a group can be saved, for example, to invite the same members for a next ride.

According to an embodiment, the present technology provides an “assistant” capability for automatically populating new groups created by a user with suggested members based on various factors, including friend lists and geolocation data.

According to an embodiment, the system's automatic population feature streamlines group creation by reducing the need for manual selection, while also providing flexibility in managing group membership. This enables users to quickly form groups with friends who are physically present before a ride commences, while also accommodating any last-minute additions or exclusions.

According to an embodiment, the system 200 is configured to continuously monitor geolocation data of vehicles associated with invited drivers to facilitate automatic formation of riding groups. This continuous monitoring enables the system 200 to track the real-time positions of all invited drivers and determine when they are in sufficient proximity to form a cohesive riding group.

More specifically, each processing module 210 can be configured to continuously monitor geolocation data of vehicles associated with invited drivers and to automatically form the new riding group when a predetermined number of invited drivers are within the predetermined range from each other. This automated approach eliminates the need for manual confirmation of group formation and ensures that riding groups are only created when members are physically present and ready to ride together. For example, when a user creates a new riding group and sends invitations to five drivers, the processing modules 210 of each invited driver's vehicle may continuously monitor their respective GPS coordinates. The system 200 may be configured such that the new riding group is automatically formed when at least three of the five invited drivers (the predetermined number) are within 200 meters (the predetermined range) from each other. This automatic formation ensures that the riding group is established only when a sufficient number of members are physically present and ready to commence the ride.

According to an embodiment, the continuous monitoring of geolocation data is performed using the GPS sensors comprised within each vehicle's set of sensors 220. The processing modules 210 may receive GPS data at regular intervals, such as every second or every few seconds, allowing for real-time tracking of vehicle positions. This frequent updating ensures that the system 200 can respond quickly to changes in vehicle positions and form riding groups as soon as the predetermined conditions are met.

According to an embodiment, the predetermined number of invited drivers required for automatic group formation can be configured by the user creating the riding group. For instance, a user may specify that the riding group should be formed when at least two, three, or any other number of invited drivers are within the predetermined range. This flexibility allows users to customize the group formation criteria based on the nature of the planned ride and their preferences.

According to an embodiment, the system 200 is configured to dynamically determine the predetermined range based on various contextual factors. This adaptive approach ensures that the predetermined range is appropriate for the specific riding conditions and user preferences, thereby enhancing the reliability and usability of the group formation functionality. More specifically, each processing module 210 can be configured to determine the predetermined range based on at least one of: a type of terrain, a type of vehicle, weather conditions, or a user-defined preference. By considering these factors, the system 200 can adjust the predetermined range to account for different riding scenarios and ensure that riding groups are formed under appropriate conditions. For example, when riding in off-road terrain with limited visibility and challenging navigation, the processing module 210 may determine a smaller predetermined range (e.g., 100 meters) to ensure that group members remain in close proximity for coordination purposes. Conversely, when riding on open highways with good visibility, the processing module 210 may determine a larger predetermined range (e.g., 500 meters) to accommodate the higher speeds and greater distances between vehicles that are typical in such environments.

According to an embodiment, the type of terrain is determined using map data stored in the memory 270 or obtained from external sources via the communication module 230. The processing module 210 may analyze the map data to identify terrain characteristics such as road type (highway, urban street, off-road trail), elevation changes, and vegetation density. Based on these characteristics, the processing module 210 can select an appropriate predetermined range from a set of predefined values or can calculate a custom range using a predetermined algorithm.

The type of vehicle can also be considered when determining the predetermined range. Different types of vehicles have different capabilities and typical riding patterns. For instance, motorcycles may travel at higher speeds and maintain greater distances between vehicles compared to all-terrain vehicles or side-by-side vehicles. The processing module 210 can access vehicle type information from the vehicle profile associated with each user profile and adjust the predetermined range accordingly. For example, for a riding group comprising motorcycles, the predetermined range may be set to 400 meters, while for a riding group comprising all-terrain vehicles, the predetermined range may be set to 200 meters.

Weather conditions can be obtained from external data sources via the communication module 230 and/or detected using onboard sensors comprised within the set of sensors 220. Weather conditions such as rain, fog, snow, or strong winds can significantly impact visibility and vehicle handling, necessitating adjustments to the predetermined range. For example, in foggy conditions with reduced visibility, the processing module 210 may reduce the predetermined range, for example to 150 meters to ensure that group members can maintain visual contact with each other. In clear weather conditions, the predetermined range may be increased, for example to 300 meters or more.

User-defined preferences may allow users to manually specify their preferred predetermined range through the user interface 260. This feature provides users with direct control over the group formation criteria and allows them to customize the system 200 based on their personal preferences and riding style. For example, a user who prefers to ride in tight formation with close coordination may specify a predetermined range of 100 meters, while a user who prefers a more relaxed riding style may specify a predetermined range of 400 meters.

According to an embodiment, the processing module 210 combines multiple factors when determining the predetermined range. For instance, the processing module 210 may use a weighted algorithm that considers terrain type, vehicle type, weather conditions, and user-defined preferences to calculate an optimal predetermined range. This multi-factor approach ensures that the predetermined range is appropriate for the specific riding conditions and user preferences.

According to an embodiment, the present technology is configured to create and manage riding groups. The present technology is designed to facilitate efficient and effective riding groups creation and management.

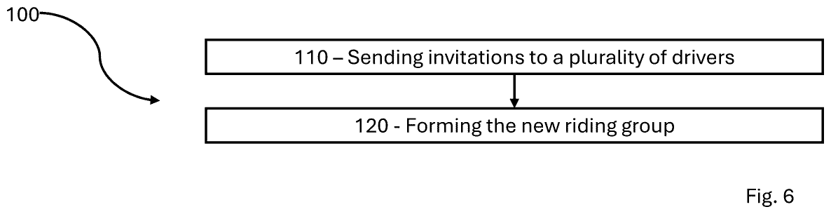

According to an embodiment, and as illustrated by FIG. 6, the present technology relates to a method 100 for managing a riding group comprising a plurality of vehicles riding together, each vehicle of the riding group being associated with a processing module 210, each vehicle of the riding group comprising a set of sensors 220, and a communication module 230. The method 100 can comprises managing a riding group by:
sending 110 invitations to a plurality of drivers to be part of a new riding group in response to the creation of the new riding group by a user; and
forming 120 the new riding group in response to at least two invited drivers being within a predetermined range from each other.

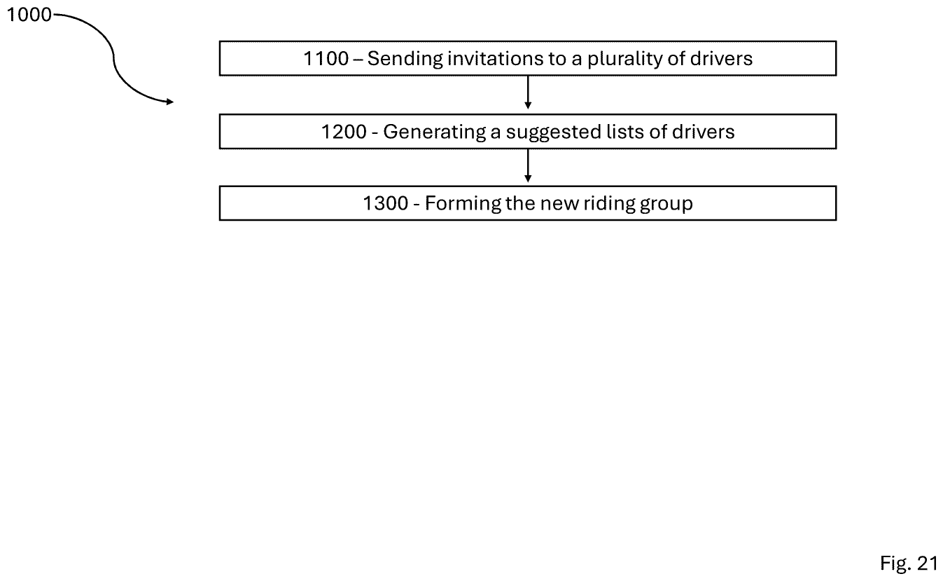

According to another embodiment, and as illustrated by FIG. 21, the present technology relates to a method 1000 for managing a riding group comprising a plurality of vehicles riding together, each vehicle of the riding group being associated with a processing module 210, each vehicle of the riding group comprising a set of sensors 220, and a communication module 230. The method 1000 can comprises managing a riding group by:
sending 1100 invitations to a plurality of drivers to be part of a new riding group in response to the creation of the new riding group by a user;
generating 1200 a suggested lists of drivers by provisionally populating the new riding group created by the user based on predetermined factors, the predetermined factors comprising for example geolocation data; and
forming 1300 the new riding group in response to at least two invited drivers being within a predetermined range from each other.

According to an embodiment, the present technology relates to systems and methods for managing the removal or the addition of a vehicle from a riding group.

According to an embodiment, the present technology relates to a system and a method for managing a riding group of vehicles. The method can comprise the steps of:
detecting the presence and identifying the unique identifiers of each vehicle in the group using sensors;
determining the position of each vehicle within the group based on the collected sensor data; and
transmitting this position information to other vehicles in the group for optimal alert distribution.

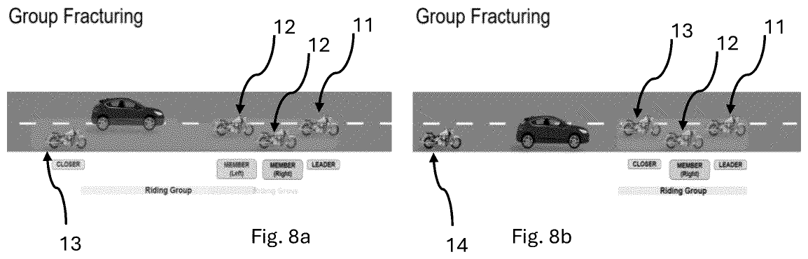

According to an embodiment, the present technology relates to systems and methods for managing group fracturing and group reforming. According to an embodiment, and as illustrated by FIGS. 8a and 8b, the present technology is configured to manage a group fracturing situation. When a rider exits the riding group, the present technology is configured to detect this event and update the group's configuration accordingly.

For example, reasons for group fracturing may include:
A rider being overtaken by another vehicle and losing direct connection to the group;
A rider voluntarily leaving the group by taking an alternate route (e.g., to end the ride);
Other scenarios where a rider is no longer part of the group.

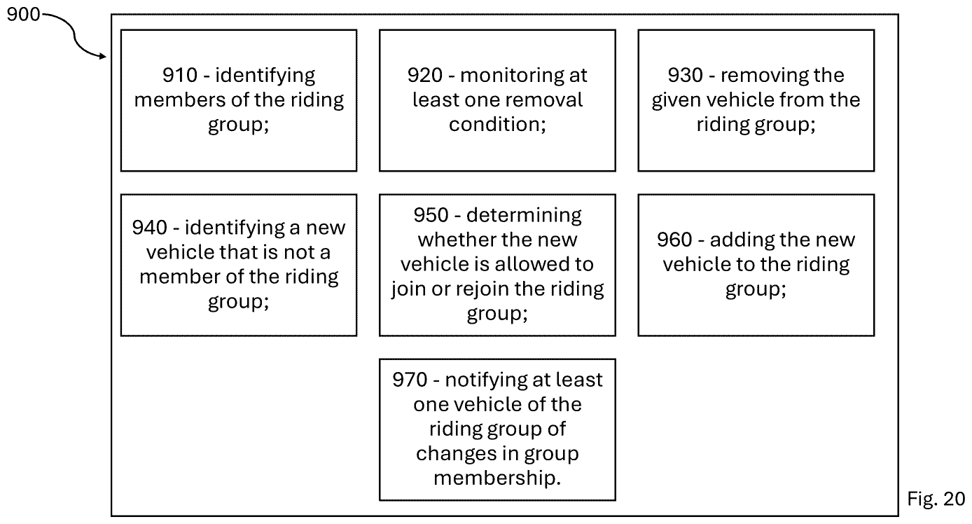

According to an embodiment, and as illustrated by FIG. 20, the present technology relates to a method 900 for managing membership of a riding group comprising a plurality of vehicles riding together. Each vehicle of the riding group is associated with a processing module, and each vehicle comprises a set of sensors and a communication module. The method may comprise managing group membership by performing several coordinated operations to maintain the integrity and/or composition of the riding group.

The method can comprise identifying 910 members of the riding group. This identification step allows the system to maintain an accurate and up-to-date roster of all vehicles currently participating in the riding group. The identification may be performed continuously or at predetermined intervals to ensure that the system has current information about group composition.

The method may further comprise monitoring 920 at least one removal condition associated with a given vehicle of the riding group. This monitoring step enables the system to detect situations where a vehicle may need to be removed from the riding group. The removal condition may comprise various factors such as distance thresholds, loss of communication, explicit user commands, or other predetermined criteria that indicate a vehicle is no longer actively participating in the riding group. The method may comprise removing 930 the given vehicle from the riding group in response to the at least one removal condition being met. This removal step ensures that the riding group composition accurately reflects the current state of vehicles actively riding together. The removal may trigger updates to the group roster and/or may initiate notifications to other members of the riding group.

The method may also comprise identifying 940 a new vehicle that is not a member of the riding group. This identification step allows the system to detect potential candidates for joining or rejoining the riding group. The identification may be performed using sensor data, communication signals, or other detection mechanisms to recognize vehicles in proximity to the riding group. Additionally, the method can comprise determining 950 whether the new vehicle is allowed to join or rejoin the riding group based on at least one predetermined criterion. This determination step provides a security and authorization mechanism to ensure that only appropriate vehicles are added to the riding group. The predetermined criterion may comprise verification of identification numbers, user profiles, group profiles, vehicle profiles, or other authentication factors. The method may further comprise adding 960 the new vehicle to the riding group in response to the new vehicle meeting the at least one predetermined criterion. This addition step integrates the new vehicle into the riding group, updating the group roster and enabling communication and coordination between the new vehicle and existing group members. The addition may also comprise updating position information and other relevant data about the new vehicle.

The method can also comprise notifying 970 at least one vehicle of the riding group of changes in group membership. This notification step ensures that all members of the riding group are informed of additions or removals, maintaining situational awareness and enabling appropriate responses to changes in group composition. The notifications may be displayed on user interfaces, communicated through audio alerts, or transmitted through other notification mechanisms to ensure that drivers are aware of membership changes.

According to an embodiment, the present technology relates to a system for identifying a new vehicle in relation to a riding group. The system may comprise one or more processing modules configured to continuously scan surroundings to identify a new vehicle. This continuous scanning capability enables the system to maintain real-time awareness of vehicles in the vicinity of the riding group, facilitating prompt detection of potential new members.

The system can be configured to identify the new vehicle in response to the new vehicle entering a predetermined range of the riding group. This range-based identification ensures that only vehicles within a relevant proximity are considered as potential candidates for joining the riding group. The predetermined range may be configured based on various factors such as the type of vehicles in the riding group, the riding environment (e.g., highway, off-road, urban), or user preferences. For example, the predetermined range may be set to 50 meters, 100 meters, or any other suitable distance that balances the need for timely detection with the avoidance of false positives from vehicles that are merely passing by.

According to this embodiment, the new vehicle comprises a processing module, and the system is further configured to scan the surroundings of the processing module of the new vehicle to identify the riding group. This bidirectional scanning capability enables both the riding group and the new vehicle to detect each other, facilitating mutual recognition and improving the reliability of the identification process. The processing module of the new vehicle may utilize its onboard sensors and communication capabilities to detect the presence of the riding group in its vicinity.

The system may be configured to identify the new vehicle in response to the new vehicle being within a predetermined distance for at least a predetermined amount of time. This time-based criterion helps to distinguish between vehicles that are genuinely traveling alongside the riding group and those that are merely passing by temporarily. For example, the predetermined distance may be set to 30 meters, 50 meters, or another suitable threshold, while the predetermined amount of time may be set to 5 seconds, 10 seconds, 30 seconds, or another duration that indicates sustained proximity rather than transient proximity.

According to an embodiment, the continuous scanning performed by the processing modules may utilize various sensor technologies including cameras, LiDAR, radar, GPS, or combinations thereof. The scanning process may employ image recognition algorithms, machine learning models, or pre-trained neural networks to accurately identify and classify vehicles in the surroundings.

The system may be configured to filter out false positives by verifying that the identified new vehicle is not already a member of the riding group. This verification step prevents duplicate entries and ensures the integrity of the group membership roster. The verification may be performed by comparing identification numbers, vehicle profiles, or other unique identifiers associated with each vehicle in the riding group.

According to an embodiment, the bidirectional scanning capability enables the new vehicle to independently assess whether it wishes to join the detected riding group. The processing module of the new vehicle may receive information about the riding group, such as group profiles, member identities, or destination information, allowing the driver of the new vehicle to make an informed decision about requesting to join the group.

The combination of range-based detection, time-based persistence criteria, and bidirectional scanning provides a robust and reliable mechanism for identifying new vehicles that are genuinely candidates for joining the riding group, while minimizing false detections and ensuring that group membership changes reflect actual riding patterns and user intentions.

According to an embodiment, the method for managing communication between vehicles of a riding group comprises implementing a dynamic group member identification mechanism that can continuously maintain awareness of group composition and may filter alerts based on real-time identification of detected vehicles as group members or non-group members.

The method can comprises maintaining a dynamic list of vehicle identifiers for all vehicles in the riding group. This dynamic list may serve as a reference database that identifies which vehicles are legitimate members of the riding group and should be excluded from alert generation. For example, the dynamic list comprises unique identifiers for each group member vehicle, such as vehicle identification numbers (VINs), MAC addresses of communication modules 230, unique cryptographic keys assigned during group formation, or user profile identifiers associated with each vehicle.

The dynamic list can be maintained in a dynamic manner, meaning it can be continuously updated to reflect changes in group composition. For example, when a new vehicle joins the riding group, its identifier is added to the dynamic list. When a vehicle leaves the riding group (either intentionally or due to separation beyond proximity thresholds), its identifier is removed from or flagged as inactive in the dynamic list.

The dynamic list may be maintained in a distributed manner, wherein each processing module 210 maintains its own copy of the list and updates are synchronized across all group members, for example through V2V or V2X communication. Alternatively, the dynamic list may be maintained in a centralized manner by a designated group coordinator (such as the leader vehicle's processing module), with other vehicles querying the coordinator to verify group membership.

The method may further comprise receiving identification data from detected vehicles, for example via V2V or V2X communication. When the set of sensors 220 detects a vehicle in proximity, the processing module 210 may attempt to establish communication with the detected vehicle to query its identity. This communication may be accomplished through standardized V2V communication protocols that support identity exchange, such as Dedicated Short-Range Communications (DSRC) or Cellular V2X (C-V2X) protocols. The identification data received from detected vehicles may comprise for example the vehicle's unique identifier, authentication credentials to verify the legitimacy of the identifier, the vehicle's current position and velocity, and optionally, the vehicle's group membership status. The identification data exchange may be secured through cryptographic authentication to prevent spoofing or unauthorized vehicles from falsely claiming group membership.

The method can further comprise comparing the identification data of detected vehicles with the dynamic list. This comparison determines whether the detected vehicle's identifier matches any identifier in the dynamic list of group members.

Based on the comparison, the method may comprise classifying detected vehicles as group members or non-group members. If the detected vehicle's identifier matches an entry in the dynamic list, the vehicle can be classified as a group member. If the detected vehicle's identifier does not match any entry in the dynamic list, or if no identification data is received from the detected vehicle (indicating it may not be equipped with V2V communication or may not be participating in group communications), the vehicle can be classified as a non-group member.

According to an embodiment, the classification may implement additional verification steps beyond simple identifier matching. For example, even if a detected vehicle's identifier matches the dynamic list, the processing module 210 may verify that the detected vehicle's position is consistent with the expected position of that group member based on recent position updates. This additional verification prevents false classification in scenarios where communication errors or malicious actors might cause identifier confusion.

The method may comprise generating alerts, also called position-specific alerts, only for detected vehicles classified as non-group members. This filtering ensures that alerts are generated only for genuine threats from vehicles outside the riding group, while suppressing alerts that would otherwise be triggered by legitimate group members riding in close proximity.

The position-specific alerts can be tailored to the riding position of the vehicle generating the alert. For example, if the first vehicle has the leader position and detects a non-group member vehicle ahead, a forward proximity alert can be generated. If the first vehicle has a member position and detects a non-group member vehicle on the left or right side, a blind spot alert can be generated. If the first vehicle has the closer position and detects a non-group member vehicle behind, a rear proximity alert can be generated.

According to an embodiment, the method may implement a grace period or hysteresis mechanism to prevent rapid alert toggling in scenarios where vehicle classification may be temporarily ambiguous. For example, if a detected vehicle is initially classified as a non-group member and an alert is generated, but the vehicle is subsequently identified as a group member (such as when delayed V2V communication finally establishes the vehicle's identity), the alert may be maintained for a minimum duration before being suppressed to avoid confusing the driver with rapidly appearing and disappearing alerts.

The dynamic group member identification mechanism significantly enhances the reliability and usability of the alert system by ensuring that alerts accurately reflect genuine threats while filtering out false alerts caused by group members. This intelligent filtering is accomplished through real-time communication and identification, enabling the system 200 to adapt continuously to the dynamic nature of group riding scenarios.

According to an embodiment, the method may be extended to support hierarchical group structures, wherein a riding group may comprise sub-groups or affiliated groups. In such scenarios, the dynamic list may comprise multiple tiers of identifiers, with different filtering rules applied based on the relationship between the detecting vehicle and the detected vehicle. For example, vehicles in the same immediate sub-group may be fully filtered from alerts, while vehicles in affiliated sub-groups may trigger reduced-severity alerts or informational notifications rather than full warnings.

According to an embodiment, to implement some of these various functions, various approaches can be taken. Here are three examples of implementation according to three embodiments of the present technology:

### Example 1: Monitoring Distances Between Vehicles

The system 200 may monitor, for example using the processing module 210 and the set of sensors 220, distances between each vehicle in the riding group and the next one using GPS data, image data, distance data, or other sensor data. Each vehicle is associated with a numerical rank corresponding to its position (e.g., leader, closer, member). The processing module 210 of each vehicle monitors the distance to vehicles with adjacent ranks. When a distance between a vehicle and the next one in front exceeds a first warning threshold, the system 200 displays a warning message (e.g., “You are about to leave the riding group”), see for example FIG. 1c. If the distance exceeds a second threshold, the system 200 notifies other vehicles that the rider has left the group. Optionally, the system 200 can display a notification on other vehicles' screens with a message such as “X left the riding group” or “X has split from the group.” However, this methodology requires riders to leave the group from behind.

### Example 2: Monitoring Distances Between Vehicles and an Average Position

The system 200 may monitor distances between each vehicle in the riding group regarding an average position of the group, the center of the riding group for example. This approach is similar to Example 1 but takes into account the size of the group by varying distance thresholds based on the number of vehicles. In a variant, the system 200 can monitor two types of distances: along the riding path and perpendicular to it. The distance thresholds may differ for each type of distance, with greater thresholds for leaving the group when taking an alternate route.

### Example 3: Detecting Other Vehicles in the Surroundings

The system 200 may detect other vehicles not part of the riding group using sensor data (e.g., cameras, LiDAR) and GPS data. When another vehicle takes a position between two vehicles in the group, it effectively splits the group into a majority sub-group and a minority sub-group. When this happens, the system 200 notifies all riders that the minority sub-group has been split from the group. For example, the present technology can be configured to generate a majority sub-group and a minority sub-group in response to the detection of another vehicle not being part of the riding group and taking a position between two vehicles of the riding group, the majority sub-group comprising a number of vehicles of the riding group higher than the number of vehicles of the riding group comprised by the minority sub-group, the majority sub-group and the minority sub-group being on opposite sides of the another vehicle.

Additional options for implementing group fracturing can comprise:
Asking the driver if he wants to leave the group at the first threshold;
Allowing users to exit the riding group via a button or vocal command; and
Having multiple thresholds (e.g., warning, temporary split, leaving the group).

According to an embodiment, the system 200 is configured to form riding groups based on the proximity of invited drivers to a common reference point. This reference point-based approach provides a centralized criterion for group formation and ensures that all group members are within a defined area relative to a specific location. More specifically, each processing module 210 can be configured to form the new riding group only when all invited drivers are within the predetermined range from a common reference point. The common reference point can be determined as one of: a geographic location specified by the user, a current location of the user creating the new riding group, or an average position of all invited drivers. This approach provides flexibility in defining the reference point based on the specific needs and preferences of the user creating the riding group. For example, when a user creates a new riding group for a planned ride starting from a specific trailhead, the user may specify the geographic coordinates of the trailhead as the common reference point. The processing modules 210 of each invited driver's vehicle may then calculate the distance from their current position to the specified trailhead. The new riding group can be formed only when all invited drivers are within the predetermined range (e.g., 300 meters) from the trailhead.

The common reference point can be automatically determined as the current location of the user creating the new riding group. In this case, the processing module 210 of the user's vehicle may obtain the current GPS coordinates and may designate this location as the common reference point. The processing modules 210 of invited drivers' vehicles can then calculate their distances from this reference point.

The common reference point can be calculated as an average position (centroid) of all invited drivers. The processing module 210 may collect the current GPS coordinates of all invited drivers via the communication module 230 and may calculate the geographic centroid of these positions. This centroid can serve as the common reference point. The processing modules 210 may then calculate the distance of each invited driver from this centroid. The new riding group can be formed when all invited drivers are within the predetermined range from the centroid.

According to an embodiment, the user interface 260 provides options for the user to select the method for determining the common reference point. For example, the user interface 260 may display a menu with options such as “Use my current location,” “Specify a location on the map,” or “Use average position of invited drivers.” The user can select the preferred option, and the processing module 210 may configure the group formation logic accordingly.

According to an embodiment, the system 200 is configured to define and/or utilize multiple predetermined ranges for different aspects of riding group management More specifically, each processing module 210 can be configured to define multiple predetermined ranges comprising a first range for automatic group formation and a second range for suggesting potential group members, the second range being greater than the first range. This dual-range approach allows the system 200 to distinguish between drivers who are close enough to form an immediate riding group and drivers who are nearby and could potentially join the group. For example, the processing module 210 may define a first range of 200 meters for automatic group formation and a second range of 500 meters for suggesting potential group members. When a user creates a new riding group, the system 200 may automatically form the group with invited drivers who are within 200 meters of each other. Additionally, the system 200 may identify other invited drivers who are within 500 meters but not within 200 meters and displays these drivers as potential group members who could join the group if they move closer.

According to an embodiment, the first range for automatic group formation is configured to ensure that only drivers who are in immediate proximity are included in the riding group. This ensures that the riding group comprises vehicles that can effectively communicate, coordinate, and ride together as a cohesive unit. The first range is typically smaller and may reflect the practical distance within which vehicles can maintain visual contact and coordinated movement.

According to an embodiment, the second range for suggesting potential group members is configured to identify drivers who are nearby but not yet close enough for automatic inclusion in the riding group. These drivers can be presented to the user as suggestions, and the user can choose to wait for these drivers to approach or can send them notifications encouraging them to join the group. The second range is typically larger than the first range and may reflect a broader geographic area within which potential group members may be located.

According to an embodiment, the user interface 260 displays the invited drivers in different categories based on their proximity to the common reference point or to other group members. For example, the user interface 260 may display a first list of drivers who are within the first range and are automatically included in the riding group, and a second list of drivers who are within the second range but not within the first range and are suggested as potential group members. This visual distinction helps the user understand the current status of group formation and make informed decisions about waiting for additional members or proceeding with the current group composition.

The processing module 210 can be configured to send notifications to drivers who are within the second range but not within the first range, informing them that a riding group is forming nearby and encouraging them to move closer to join the group. These notifications can be displayed on the user interface 260 of the invited driver's vehicle and may include information such as the distance to the common reference point, the number of drivers already in the group, and estimated time to reach the group location, for example.

The system 200 can define additional predetermined ranges for other purposes. For example, a third range may be defined for monitoring purposes, where drivers who are within this third range are tracked by the system 200 but not actively suggested as potential group members. This third range may be used to maintain awareness of nearby riders who may become relevant in the future, such as when the riding group changes location or when additional riders are needed.

According to an embodiment, the method for managing a riding group comprises calculating distances between invited drivers, generating a proximity matrix, and forming the riding group based on connectivity analysis of the proximity matrix. This matrix-based approach provides a systematic and comprehensive method for determining which invited drivers should be included in the riding group based on their spatial relationships. More specifically, the method may further comprise: calculating distances between each pair of invited drivers using their respective GPS coordinates; comparing each calculated distance with the predetermined range; generating a proximity matrix indicating which invited drivers are within the predetermined range from each other; and forming the new riding group when the proximity matrix indicates that a sufficient number of invited drivers form a connected group wherein each invited driver is within the predetermined range from at least one other invited driver.

For example, consider a scenario where five drivers (Driver A, Driver B, Driver C, Driver D, and Driver E) have been invited to join a new riding group. The processing module 210 may calculate the distances between each pair of drivers: A-B, A-C, A-D, A-E, B-C, B-D, B-E, C-D, C-E, and D-E. The processing module 210 may then compare each calculated distance with the predetermined range (e.g., 250 meters) and generates a proximity matrix where each entry indicates whether the corresponding pair of drivers is within the predetermined range (represented as “1”) or not (represented as “0”). According to an embodiment, the proximity matrix is a symmetric matrix where rows and columns represent the invited drivers, and each entry (i, j) indicates whether driver i and driver j are within the predetermined range from each other. For example, if Driver A and Driver B are within 250 meters of each other, the entry (A, B) in the proximity matrix is set to “1”. If Driver A and Driver D are more than 250 meters apart, the entry (A, D) is set to “0”.

The processing module 210 may analyze the proximity matrix to identify connected groups of drivers. A connected group can be defined as a subset of invited drivers where each driver is within the predetermined range from at least one other driver in the subset. This connectivity analysis can be performed using graph theory algorithms, where each driver is represented as a node and each proximity relationship (entry of “1” in the proximity matrix) is represented as an edge connecting two nodes. The processing module 210 can identify connected components in this graph, where each connected component represents a potential riding group. For example, if the proximity matrix indicates that Driver A is within range of Driver B, Driver B is within range of Driver C, and Driver C is within range of Driver A, then Drivers A, B, and C form a connected group. Even if Driver D is within range of Driver E but not within range of any of Drivers A, B, or C, Drivers D and E form a separate connected group. The processing module 210 can then form the new riding group with the largest connected group (Drivers A, B, and C in this example) or can form multiple riding groups corresponding to each connected component.

According to an embodiment, the criterion for forming the new riding group based on the proximity matrix can be configured to require a minimum number of invited drivers in the connected group. For example, the processing module 210 may be configured to form the new riding group only when the proximity matrix indicates that at least three invited drivers form a connected group.

The processing module 210 may continuously update the proximity matrix as invited drivers move and their GPS coordinates change. This dynamic updating ensures that the proximity matrix accurately reflects the current spatial relationships between invited drivers at all times. When the proximity matrix changes such that a sufficient number of invited drivers form a connected group, the processing module 210 may automatically trigger the formation of the new riding group.

The user interface 260 can display a visual representation of the proximity matrix and/or the connectivity graph to the user creating the riding group. This visualization may help the user understand which invited drivers are in proximity to each other and which drivers form connected groups. For example, the user interface 260 may display a map showing the locations of all invited drivers, with lines connecting drivers who are within the predetermined range from each other.

The proximity matrix-based approach can provide robustness in scenarios where invited drivers are distributed across a geographic area in complex spatial patterns. By analyzing connectivity rather than simply measuring distances from a single reference point, the system 200 can identify cohesive subgroups of drivers who are in proximity to each other, even if they are not all close to a common central location. This approach is particularly useful in off-road riding scenarios where terrain features may cause drivers to be distributed in non-uniform patterns.

According to an embodiment, the method for managing a riding group comprises continuously monitoring geolocation data of vehicles associated with invited drivers and automatically forming the riding group when proximity conditions are satisfied for a predetermined duration of time. This duration-based criterion ensures that riding groups are formed only when invited drivers remain in proximity for a sufficient period, thereby preventing premature group formation due to transient proximity. More specifically, according to this embodiment, forming the new riding group comprises: continuously monitoring geolocation data of vehicles associated with the plurality of invited drivers using GPS sensors integrated into each vehicle; and automatically forming the new riding group when at least two invited drivers are within the predetermined range from each other for a predetermined duration of time. For example, the processing module 210 may be configured such that the new riding group is automatically formed when at least two invited drivers are within 200 meters of each other for at least 30 seconds. This duration criterion ensures that the invited drivers are not merely passing by each other but are actually stationary or moving together in a coordinated manner, indicating their readiness to form a riding group.

The processing module 210 may calculate the distance between each pair of invited drivers based on their GPS coordinates and maintains a record of how long each pair has been within the predetermined range. When the duration for which at least two invited drivers have been within the predetermined range exceeds the predetermined duration of time, the processing module 210 triggers the automatic formation of the new riding group.

The predetermined duration of time can be configured by the user creating the riding group and/or can be set to a default value by the system 200. For example, the user interface 260 may provide an option for the user to specify the predetermined duration of time, such as 15 seconds, 30 seconds, 60 seconds, or any other suitable value. The duration-based criterion may help prevent false positives in group formation. For instance, if two invited drivers happen to pass by each other briefly while traveling in different directions, the system 200 will not automatically form a riding group because the proximity condition is not satisfied for the predetermined duration of time. This ensures that riding groups are formed only when invited drivers are genuinely intending to ride together.

According to an embodiment, the processing module 210 provides feedback to invited drivers regarding the status of group formation. For example, the user interface 260 may display a message such as “Proximity detected. Group will form in 20 seconds if you remain within range.” This feedback informs drivers of the impending group formation and allows them to adjust their position if needed.

According to an embodiment, dissolving the new riding group occurs when the riding group has already been formed but invited drivers subsequently move outside the dynamically adjusted predetermined range. For example, if the riding group is traveling together and the terrain changes from a flat road to a mountainous area with steep elevation changes, the processing module 210 may dynamically reduce the predetermined range to account for the increased difficulty of maintaining proximity in mountainous terrain. If the distance between group members exceeds the newly adjusted predetermined range, the processing module 210 may dissolve the riding group and notify all members via the communication module 230. The notification may state: “Riding group dissolved due to excessive distance between members under current terrain conditions.”

Before dissolving the riding group, the processing module 210 may implement a grace period or warning system. For example, when invited drivers begin to move outside the dynamically adjusted predetermined range, the processing module 210 may first display a warning message on the user interface 260 of each vehicle, such as: “Warning: Group members are moving outside the acceptable range. Please reduce distance to maintain group cohesion.” If the condition persists for a predetermined duration (e.g., 60 seconds), the processing module 210 then proceeds to dissolve the riding group. This grace period allows drivers an opportunity to adjust their positions and maintain the riding group before it is dissolved.

According to an embodiment, the user interface 260 displays information about the current predetermined range and the factors influencing its adjustment. For example, the user interface 260 may display a message such as: “Current group range: 250 meters (adjusted for off-road terrain and foggy conditions).” This transparency helps users understand why the predetermined range has been set to a particular value and allows them to make informed decisions about their riding behavior and group participation.

The processing module 210 may log all dynamic adjustments to the predetermined range along with the contextual factors that triggered each adjustment. This logged data can be stored in the memory 270 and used for subsequent analysis, system optimization, or user review. For example, users may review the log after a ride to understand how the predetermined range changed throughout the ride and how these changes affected group formation and dissolution events.

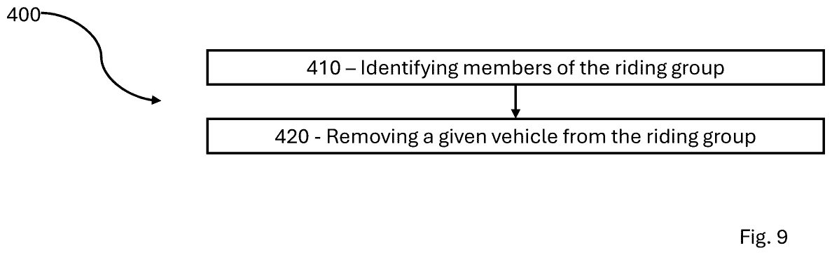

According to an embodiment, and as illustrated by FIG. 9, the present technology relates to a method 400 for managing group fracturing in response to a given vehicle of the plurality of vehicles exiting the riding group by:
identifying 410 members of the riding group; and
removing 420 a given vehicle from the riding group in response to a predetermined condition being met.

According to an embodiment, the predetermined condition comprises at least one of:
receiving a notification from the given vehicle, the notification being generated in response to a command of driver of the given vehicle;
losing a direct connection to the given vehicle in response to the given vehicle being overtaken by another vehicle outside of the riding group; or
detecting the given vehicle at a distance from at least one of the vehicles of the riding group greater than a predetermined threshold.

The management of the fracturing of the group can comprise monitoring at least one of:
distances between each vehicle of the riding group using sensor data from a corresponding set of sensors; or
distances between each vehicle in the riding group with respect to an average position of the riding group.

According to an embodiment, managing the fracturing of the group can comprise displaying a warning message to the driver of the given vehicle in response to the distance of the given vehicle to a vehicle of the riding group being greater than a first threshold, the first threshold being lower than the predetermined threshold.

For example, the driver of the given vehicle can just push a button or an icon on a screen or use a vocal command to leave the riding group.

According to an embodiment, the method can comprise monitoring the distances between each vehicle in the group and the average position of the entire group. The monitoring can occur not only along the riding path but also perpendicular to it. For instance, if two vehicles are drifting apart from each other while traveling parallel, the system 200 will detect this deviation and alert the drivers accordingly.

In some instances, a vehicle may stray too far from the average position of the riding group, necessitating action from the system 200. The method can for example be configured to allow for the splitting of the riding group in response to such occurrences. For example, if a driver decides to explore an area away from the group or if his vehicle experiences mechanical issues, the driver can be removed from the group and managed separately.

Before a vehicle is removed from the riding group, the driver of this vehicle may be given the opportunity to confirm their intent. This confirmation can take various forms, such as pressing a button on their vehicle's control panel or issuing a vocal command. By requiring this confirmation, the system 200 ensures that the driver's intention is clear and deliberate before any actions are taken. According to an embodiment, the driver can also initiate his departure from the riding group pressing a button or an icon on a screen on their vehicle's control panel or issuing a vocal command.

When a vehicle leaves the riding group, it is useful that the remaining vehicles are informed of this change. The method can comprise displaying warnings to the other vehicles in the group to alert them of the departure. This feature ensures that all divers remain aware of their surroundings and can adjust their actions accordingly.

According to an embodiment, each set of sensors 220 used in the system 200 is equipped with a perception-based sensor, which can be used in identifying the vehicles that belong to the riding group. Utilizing pre-trained neural networks can enhance the accuracy and efficiency of this identification process by enabling the system 200 to quickly and reliably distinguish between group members and external vehicles.

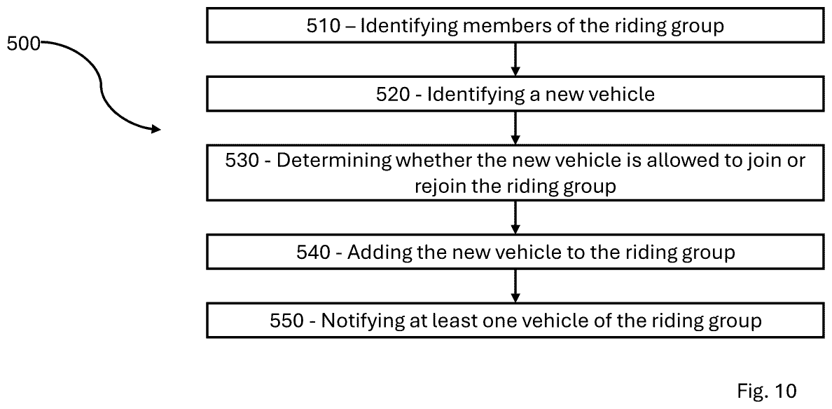

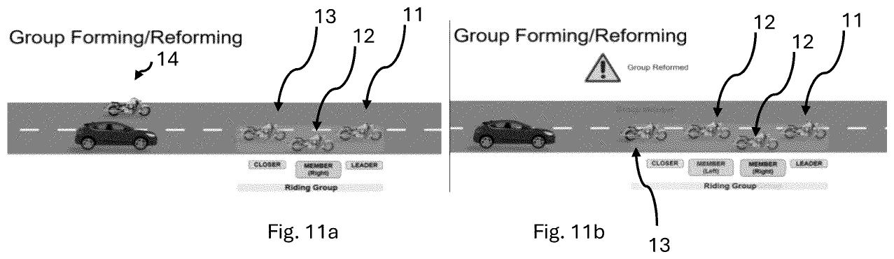

According to an embodiment, and as illustrated by FIGS. 10, 11a and 11b, the present technology relates to a method 500 for managing group forming and/or reforming by:
identifying 510 members of the riding group;
identifying 520 a new vehicle 14 that is not a member of the riding group;
determining 530 whether the new vehicle 14 is allowed to join or rejoin the riding group based on at least one predetermined criterion;
adding 540 the new vehicle 14 to the riding group in response to the new vehicle 14 meeting the at least one predetermined criterion; and
notifying 550 at least one vehicle 11, 12, 13 of the riding group of the new vehicle 14 being added to the riding group. In the illustrated example, the detected vehicle 14 becomes the closer vehicle 13 once it has joined the riding group.

The identification of a new vehicle 14 can be based on specific criteria. These criteria may comprise the new vehicle 14 being within a predetermined distance for a certain amount of time from at least one processing module 210 of the vehicles 11, 12, 13 in the riding group, or spending a number of seconds higher than a predetermined number of seconds at a distance smaller than a predetermined distance from one of the processing modules 210 of the vehicles 11, 12, 13 of the riding group. According to an embodiment, if the new vehicle 14 has a processing module 210 on board, the method can be configured to scan the surroundings of this processing module 210 to identify the riding group it belongs to.

Once a new vehicle 14 is identified, the method may proceed with verifying its membership status within the riding group. To prevent duplicate vehicles from being added to the riding group, the method verifies that the identified new vehicle is not already a part of the group.

After identifying and verifying a new vehicle 14, the method receives at least one piece of information from this new vehicle 14, such as its identification number, user profile, group profile, or vehicle profile. This information is useful for determining if the new vehicle 14 is allowed to join or rejoin the riding group.

Based on the received information, the method can be configured to make a decision about whether to allow the new vehicle 14 to join or rejoin the riding group. This decision may be based on various factors, such as the identification number, user profile, group profile, or vehicle profile of the new vehicle 14. By carefully considering these factors, the method ensures that only authorized vehicles are added to the riding group.

The method can also be configured to check if the new vehicle 14 was previously a part of the riding group using the same received information.

After a new vehicle 14 has been identified, verified, and authorized to join the group, its position is added to the riding group.

According to an embodiment, the method can also be configured to send at least one piece of information to the new vehicle 14 to allow the driver of the new vehicle 14 to decide whether to join/rejoin the riding group. This information may include an identification number, a user profile, a group profile, or a vehicle profile that the driver can use to make an informed decision about membership. For example, the new vehicle's processing module 210 is configured to verify that at least one piece of the received information is registered in predetermined lists before deciding to join the riding group.

According to an embodiment, the method can use the display devices to provide information, notifications, or warnings to the users of these vehicles and receive user input.

According to an embodiment, the present technology provides the following:
Notifying group members when the group is fractured allows the leader to better sense issues from individual riders and adjust the group trajectory as needed;
Automatically handling group fracturing/reforming ensures that all role-based functionality within each group remains functional, making it more reliable; and
Minimizing manual management efforts within the group enables riders to focus on the road rather than managing group relations.

According to an embodiment, the system 200 can be configured to detect when a user exits or joins a riding group. This detection can be achieved through various means such as the use of sensors, GPS data, or other forms of communication between vehicles in the network. According to an embodiment, upon detection of a rider's exit or joining, the system 200 automatically adjusts group roles. For instance, if a rider leaves a group, their role may be reassigned to another rider, and all members of the group are notified of the change. Furthermore, the system 200 can be configured to ensure that all role-based functionality within each group remains functional following any changes in group composition. This can comprise adjusting settings for navigation, safety features, or other applications that rely on group information.

According to an embodiment, the processing module 210 can be configured to manage group formation, fracturing, and reforming based on user input and automatic detection of geographic proximity.

According to an embodiment, the method comprises integrating social media platforms within a riding group. This integration enables users to import their friend lists from social media platforms (for example through a user-friendly interface). The system 200 can use this imported information to facilitate easy group creation and communication between friends.

In more detail, the method allows users to seamlessly connect their social media accounts with their vehicle's processing module 210. By importing their friend lists, the system 200 can recognize existing connections and suggest creating groups based on these relationships (for example reducing the need for manual group creation). Furthermore, this integration enables real-time communication between friends while they are in their vehicles, enhancing the overall driving experience.

According to an embodiment, the method involves integrating music streaming services within a vehicle communication module 230. This integration enables users to access their preferred music streaming service through the system 200.

For example, the system 200 provides synchronized playback between vehicles in the group. This feature allows riders to enjoy their favorite music together during rides or events. For example, each vehicle is connected in the communication module 230, ensuring seamless music streaming and synchronization.

Additionally, the method can comprise a user interface within the vehicle system 200 that displays the available music streaming services for selection by the user. Once selected, the system 200 connects to the chosen service and begins synchronized playback across all vehicles in the group.

### Detection of Potential Threats

According to an embodiment, the present technology relates to systems and methods for managing communication between vehicles of a riding group of vehicles. For example, such a system or method can be configured to detect potential threats.

In a broad aspect and according to an embodiment, the present technology comprises a group of vehicles, each vehicle of the group of vehicles being equipped with a processing module 210, a set of sensors 220 to sense its surroundings, and a communication module 230. These sets of sensors may comprise, but are not limited to, cameras, lidar, radar, ultrasonic sensors, or any other suitable sensing technology, as previously described. According to an embodiment, the sets of sensors continuously monitor the environment around the corresponding vehicle and detect potential threats based on predefined criteria.

In this embodiment, the processing module 210 of the leader 11 comprises a threat detection module 211. The threat detection module 211 is configured to identify obstacles in the environment of the leader 11 based on sensor signal and image-recognition algorithms. The detected obstacles may be categorized in two categories: static obstacles and moving obstacles. According to an embodiment, the threat detection module is comprised by the processing module 210.

Examples of static obstacles may include holes (e.g., potholes, crevices, cavities, etc.), impeding objects (rocks, ice blocks, sign posts, etc.), topography elements (walls, cliffs, etc.). The threat detection module 211 may determine a static obstacle is a threat when its size is above a pre-determined threshold, its distance relative to the vehicle is below a threshold (e.g., less than 50 m), and it is on or close to (below a pre-determined threshold, e.g., +/−15°, 30°, 45°, etc.) a projected trajectory of the vehicle.

Examples of moving objects may include other vehicles (of the same type or of different types), pedestrians, animals, inanimate objects. The threat detection module 221 may predict a trajectory of the moving object based at least on its speed and direction. The threat determination module 211 may determine a moving obstacle is a threat when it its distance relative to the vehicle is below a threshold (e.g., less than 50 m) and its projected trajectory intersects with or is close to (below a pre-determined threshold, e.g., +/−15°, 30°, 45°, etc.) intersecting with the projected trajectory of the vehicle. Respective thresholds may be pre-determined based at least on the type of moving object determined by the threat detection module 211 at the image recognition stage. For instance, thresholds for small animals may be more restrictive than thresholds for pedestrians (i.e., pedestrians may be identified as threats more easily).

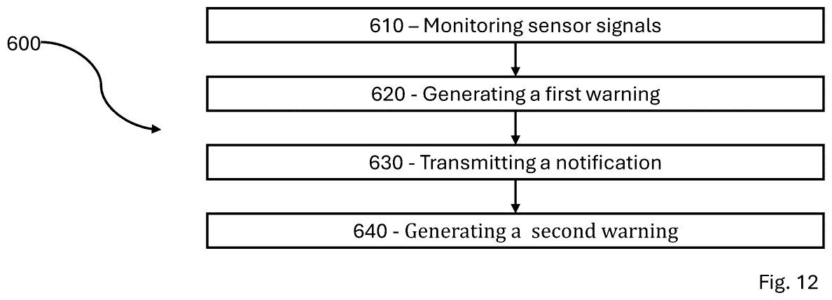

According to an embodiment, and as illustrated by FIG. 12, the method 600 for managing communication between vehicles of a riding group comprises the steps of:
Monitoring 610 sensor signals from a set of sensors 220 of a first vehicle to detect potential threats in the environment surrounding a first vehicle;
upon detection of a potential threat or obstacle by the set of sensors 220 of the first vehicle, generating an alert signal based on the detected threat or obstacle and generating 620 a first warning to a first driver of the first vehicle based on the alert signal; and
wirelessly transmitting 630 a notification comprising the alert signal to a second vehicle of the riding group; and
generating 640 a second warning to a second driver of the second vehicle based on the notification.

For example, the first processing module 210a is configured to determine a first vehicle position of the first vehicle within the riding group based on sensor data and to communicate the first vehicle position to the second processing module 210b.

For example, the second processing module 210b is configured to determine a second vehicle position of the second vehicle within the riding group based on sensor data and to communicate the second vehicle position to the first processing module 210a.

According to an embodiment, the first processing module 210a is configured to determine a vehicle position of the second vehicle within the riding group based on sensor data and to communicate the vehicle position of the second vehicle to the first driver.

According to an embodiment, the second processing module 210b is configured to determine a vehicle position of the first vehicle within the riding group based on sensor data and to communicate the vehicle position of the first vehicle to the second driver.

For example, each of the first and the second processing modules 210a and 210b is associated with a vehicle profile and a user profile of a corresponding one of the first and second vehicles.

For example, each of the first and second processing modules 210a and 210b is configured to generate and transmit alerts based on different severity levels. In general, according to an embodiment, each processing module 210 is configured to analyze data and generate alerts based on predefined criteria.

For example, each processing module 210 is capable of generating and transmitting alerts with different severity levels. This feature allows users to customize their alert settings according to their preferences and needs.

Moreover, the user interface that enables users to select the desired severity level for each alert type can also provide a visual representation of the available severity levels and their corresponding alert icons or colors.

According to an embodiment, the present technology may employ a notification system that prioritizes alerts based on their severity level. For instance, critical alerts may be displayed as pop-up notifications or audio notifications, while less severe alerts may be sent via text message, for example.

Furthermore, the present technology may comprise a rule engine that allows users to define custom alert rules based on specific conditions.

The ability to generate and transmit alerts with different severity levels can enhance the overall effectiveness of the system 200 by ensuring that users are promptly notified of critical issues while minimizing unnecessary interruptions caused by less severe alerts.

According to an embodiment, the present technology provides a system and method for detecting potential threats in the surrounding environment of a vehicle and transmitting a signal indicating the potential threat or obstacle to other vehicles in physical proximity, being part of a riding group, for example. The present technology enhances road safety by enabling real-time communication between vehicles and sharing critical information about potential hazards, reducing the likelihood of accidents, and improving overall driving experience.

According to an embodiment, the present technology relates to a method for monitoring and alerting users of certain events or conditions. The method can comprise several steps.

Firstly, data is collected from various sources. This data can be obtained through sensors, user inputs, or external feeds. According to an embodiment, the data can be preprocessed to filter out irrelevant information and normalize the data for further analysis.

Secondly, the system 200 analyzes the collected data using algorithms and models. The analysis can involve pattern recognition, anomaly detection, Kalman filter or trend analysis. According to an embodiment, machine learning techniques can be employed to improve the accuracy of the analysis over time.

Thirdly, based on the analysis results, the system 200 generates alerts. These alerts can take various forms, such as visual notifications, audible alarms, or text messages, or haptic stimulations. According to an embodiment, the severity level of each alert is determined based on predefined rules or user-defined settings.

Fourthly, the system 200 transmits the generated alerts to users, for example through multiple channels. Users can choose which channels they prefer to receive alerts from, email calls, video chat, in-app notifications, text messaging. According to an embodiment, users can customize their alert settings to suit their preferences and needs.

The system 200 can be configured to allow for real-time monitoring and timely alerts, enabling users to take swift action in response to critical events or conditions. The ability to customize alert settings also enhances user experience and satisfaction.

According to an embodiment, the method comprises the steps of:
collecting data from sensors or other sources;
processing the collected data using algorithms and/or machine learning techniques;
generating contextually relevant information based on the processed data; and
displaying the generated information to the user.

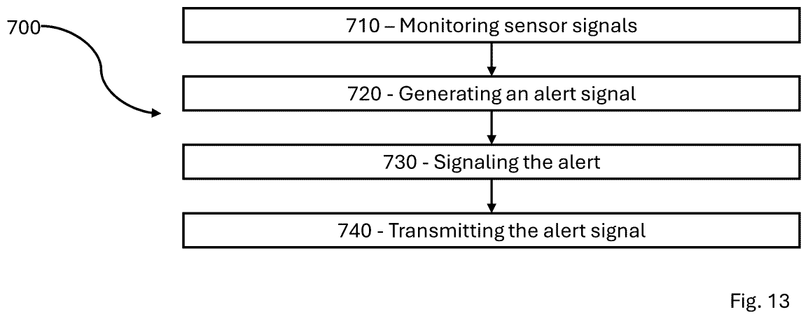

In more details, according to an embodiment, and as illustrated by FIG. 13, the method 700 for detecting potential threats in the surrounding environment of a vehicle comprises the steps of:
1. monitoring 710 sensors signals to detect potential threats in the vehicle's environment;
2. upon detection of a potential threat or obstacle by a vehicle of the riding group, generating 720 an alert signal based on the detected threat or obstacle;
3. signaling 730 the alert to the driver or passengers of the vehicle through a display or audible or haptic warning;
4. transmitting 740 the alert signal wirelessly to the other vehicles of the riding group for its awareness and potential action.

Indeed, upon detection of a potential threat or obstacle, the present technology generates an alert signal based on the detected threat or obstacle. This alert signal may comprise information such as the type, location, and severity of the threat/obstacle. The alert signal is then signaled to the driver or passengers of the vehicle through a display or audible or haptic warning/notification.

In addition to signaling the alert to the occupants of the vehicle, the present technology transmits the alert signal wirelessly to other vehicles of the riding group for their awareness and potential action. This wireless transmission may be achieved using the communication modules 230.

Each vehicle in the riding group is equipped with a processing module 210 that receives and interprets the transmitted alert signals. Each vehicle processes the received alert signal and displays it to the driver or passengers through a suitable interface, such as a dashboard display or a heads-up display using a visual, audio and/or haptic notification.

The present technology enables vehicles to communicate with each other in real-time and share critical information about potential threats in their surroundings. This enhances road safety by allowing drivers to react more quickly and effectively to hazards and reduces the likelihood of accidents.

Furthermore, the system 200 may comprise additional features such as:
Filtering false alerts caused by other vehicles in the system 200 to avoid unnecessary distractions or false alarms.
Allowing users to customize their alert preferences based on their driving style and preferences.
Integrating with external services, such as traffic information systems or weather forecasts, to provide more comprehensive threat detection capabilities.
Supporting multiple communication protocols to ensure interoperability between different vehicle makes and models.
Implementing security measures to protect against unauthorized access or data breaches.

The system 200 can be configured to allow the leader to sense issues from one rider and adjust the group trajectory accordingly, ensuring that the entire group stays safe and remains coordinated.

According to an embodiment, all the members of the riding group are aware if problem alerts arise for any group member and can adjust their driving accordingly. The system's alert generation and distribution mechanism ensures that critical information is shared among group members, facilitating coordinated adjustments to maintain safe riding conditions.

For example, riders behind the leading vehicle get advanced warning that leader may need to take emergency actions (such as to avoid a forward collision) and can preemptively adjust riding. By providing riders with early warnings of potential hazards ahead, the system 200 enables them to anticipate and prepare for emergency maneuvers by the leader. This proactive approach reduces reaction times and enhances overall group safety.

For example, riders ahead of closer get advanced notice that closer may need to take emergency actions (such as to avoid a rear collision) and can preemptively adjust riding. Similarly, riders in front of the closer vehicle receive early warnings of potential hazards behind them, allowing them to anticipate and prepare for emergency maneuvers by the closer vehicle. This coordinated approach minimizes reaction times and enhances group safety.

For example, the leading vehicle is aware when it is clear for all riders to change course right or left and can more safely lead the group: The system's alert generation mechanism informs the leader of safe opportunities to change course, enabling them to make informed decisions about navigating through complex traffic scenarios. This enhanced situational awareness enables the leader to maintain a safe distance from other vehicles and pedestrians.

For example, all riding group members are aware when a vehicle is overtaking on the left or right side of the group: By providing real-time information about overtaking vehicles, the system 200 ensures that all group members are aware of potential hazards and can adjust their riding positions accordingly. This proactive approach reduces the risk of collisions and enhances overall group safety.

According to an example, in a multi-vehicle riding group scenario, the present technology is configured to detect potential collisions or hazards based on sensor data from each vehicle. The processing module 210 of each vehicle is designed to generate alerts in response to various events, including:
Front proximity alert: When a vehicle has the leader position and its sensors detect an approaching vehicle up front with a distance below a predetermined threshold, the system 200 generates a front proximity alert. This alert may be communicated to the user of the vehicle having the leader position via various means (e.g., display, haptic feedback, speaker, distinct indicator). For example, the alert may also be transmitted to users of other vehicles in the riding group.
Rear proximity alert: When a vehicle has the closer position and its sensors detect an approaching vehicle from behind with a distance below a predetermined threshold, the system 200 generates a rear proximity alert. This alert is communicated to the user of the vehicle having the closer position via various means (e.g., display, haptic feedback, speaker, distinct indicator). For example, the alert may also be transmitted to users of other vehicles in the riding group.
Blindside proximity alert: When a vehicle is close (below a predetermined threshold) on a left or right side of any vehicle, the system 200 generates a blindside proximity alert. This alert may be communicated to each driver of each vehicle in the riding group all at once, or to drivers of vehicles on a specific left or right side of the group all at once. Alternatively, the processing module 210 of the first vehicle detecting the blind side threat may send a signal to other vehicles to prompt them to expect a blind side threat and time a blindside proximity alert accordingly.

According to an embodiment, when the first vehicle occupies the leader position 11 within the riding group, the first processing module 210a is configured to implement position-specific alert management tailored to the responsibilities associated with leading the group. In this configuration, the first processing module 210a can be configured to receive and process forward proximity alerts for vehicles detected ahead of the first vehicle within a predetermined forward distance threshold. These forward proximity alerts may be generated only when the detected vehicles are confirmed to be outside the riding group, thereby avoiding unnecessary warnings caused by legitimate group members. The predetermined forward distance threshold may be configurable based on various factors, comprising vehicle speed, road conditions, visibility, and user preferences. For example, the threshold may be set at 50 meters, 100 meters, or any other suitable distance that provides adequate warning time for the first driver to react to potential hazards. The threshold may be dynamically adjusted in real-time based on current riding conditions, such as increasing the threshold during high-speed riding or reducing it in congested areas.

Additionally, the first processing module 210a can be configured to receive blind spot alerts for vehicles detected on the left or right sides of the first vehicle within a predetermined lateral distance threshold. Similar to the forward proximity alerts, these blind spot alerts may be generated only for vehicles that are outside the riding group.

The predetermined lateral distance threshold may be established based on the typical width of riding formations and the sensor capabilities of the first vehicle. For example, the threshold may be set at 3 meters, 5 meters, or any other suitable distance that effectively identifies vehicles in the blind spot zones while filtering out group members riding in expected positions.

Upon receiving forward proximity alerts and/or blind spot alerts, the first processing module 210a may generate warnings to the first driver based on these alerts. These warnings may comprise at least one of visual notifications displayed on the display device 260, audible notifications emitted through speakers, or haptic notifications delivered through vibration mechanisms integrated into the steering wheel, seat, or other vehicle components. The warnings may be differentiated based on the type and severity of the alert, allowing the first driver to quickly assess the nature of the threat and respond appropriately.

Furthermore, the first processing module 210a can be configured to wirelessly transmit notifications comprising alerts, such as the forward proximity alerts and/or the blind spot alerts, to at least the second processing module 210b and potentially to other processing modules associated with additional vehicles in the riding group. This wireless transmission can be accomplished through the communication module 230a, which may utilize V2V (vehicle-to-vehicle) communication protocols, V2X (vehicle-to-everything) communication protocols, or other suitable wireless communication technologies.

By transmitting these notifications to other vehicles in the riding group, the system 200 enables coordinated awareness and response to potential threats. For example, when the leader vehicle detects a forward proximity threat, vehicles behind the leader can receive advance warning and prepare to adjust their riding accordingly, such as by reducing speed, increasing following distance, or preparing for evasive maneuvers.

The notifications transmitted to other vehicles may comprise additional contextual information, such as the type of threat detected (e.g., stationary obstacle, oncoming vehicle, merging vehicle), the estimated distance to the threat, the relative speed of the threat, and the recommended action (e.g., slow down, change lanes, stop). This enriched information enables other drivers in the riding group to make more informed decisions about how to respond to the detected threat.

According to an embodiment, when the second vehicle occupies a member position 12 within the riding group, the second processing module 210b can be configured to implement alert management specifically tailored to the unique situational awareness requirements of vehicles positioned between the leader 11 and the closer 13. In this configuration, the second processing module 210b may receive blind spot alerts for vehicles detected on the left or right sides of the second vehicle within the predetermined lateral distance threshold, wherein these alerts are generated only for vehicles that are outside the riding group.

The second processing module 210b can then generate warnings to the second driver based on the received blind spot alerts. These warnings may comprise at least one of visual notifications, audible notifications, or haptic notifications, as previously described.

A distinguishing feature of the member position alert management can be the implementation of intelligent alert suppression. Specifically, the second processing module 210b may be configured to suppress blind spot alerts when detected vehicles on the left or right sides are identified as being part of the riding group and riding in close proximity.

The identification of vehicles as being part of the riding group may be accomplished through various means, including V2V communication wherein vehicles exchange unique identifiers, GPS-based position correlation wherein the positions of detected vehicles are compared against known positions of group members, or sensor-based recognition wherein vehicle characteristics (such as size, shape, or distinctive markings) are matched against profiles of group members.

The determination of whether a detected vehicle is “riding in close proximity” as a legitimate group member may involve analyzing multiple factors, comprising the relative position of the detected vehicle with respect to the expected formation pattern of the riding group, the consistency of the detected vehicle's movement with the group's trajectory and speed, and the duration for which the detected vehicle has maintained its position relative to the second vehicle.

For example, if the riding group is traveling in a staggered formation with alternating left and right positions, the second processing module 210b may be configured to recognize that vehicles occupying these expected positions are legitimate group members and to suppress blind spot alerts for these vehicles. However, if a vehicle approaches from the side at a significantly different speed or trajectory than the group's movement pattern, or if the vehicle is not identified as a group member, for example through V2V communication, the second processing module 210b may generate a blind spot alert to warn the second driver of the potential threat.

According to an embodiment, the present technology is designed to filter out false alerts caused by other vehicles in the riding group through verification steps, ensuring that only genuine hazards are communicated to drivers.

According to an embodiment, the first processing module 210a is configured to implement a comprehensive false alert prevention mechanism that ensures alerts are generated only for genuine threats outside the riding group while suppressing alerts caused by legitimate group members. This mechanism can be particularly useful in group riding scenarios where multiple vehicles travel in close proximity, creating numerous potential alert triggers that, if not properly filtered, would result in reduced system effectiveness.

The false alert prevention mechanism may operate through a multi-step process. First, the first processing module 210a may continuously monitor positions of all vehicles in the riding group. This continuous monitoring can be accomplished through various means, comprising, for example, receiving position data from other processing modules 210 via V2V or V2X communication, determining positions through GPS sensors 220, inferring positions through sensor data from cameras, radar, lidar, or other sensing devices, and maintaining a dynamic database of group member positions that is updated in real-time as vehicles move.

According to an embodiment, the position monitoring occurs at a frequency sufficient to maintain accurate awareness of group member locations despite the dynamic nature of vehicle movement. For example, position updates may be received and processed at intervals of 100 milliseconds, 500 milliseconds, 1 second, or any other suitable interval that balances accuracy with computational and communication efficiency.

Second, when the set of sensors 220 detects a vehicle in proximity to the first vehicle, the first processing module 210a may compare a position of the detected vehicle with positions of vehicles in the riding group. This comparison can involve analyzing multiple parameters, comprising for example the absolute position coordinates (e.g., GPS coordinates) of the detected vehicle and known group members, the relative position of the detected vehicle with respect to the first vehicle and other group members, the trajectory and speed of the detected vehicle compared to the movement patterns of the riding group, and the unique identifier of the detected vehicle if available through V2V communication.

The comparison process may employ tolerance thresholds to account for GPS accuracy limitations, sensor measurement uncertainties, and the dynamic nature of vehicle positions. For example, if a detected vehicle's position is within 2 meters, 5 meters, or another suitable tolerance distance of a known group member's position, and if the detected vehicle's trajectory and speed are consistent with the group member's movement, the detected vehicle may be identified as that group member.

Third, the first processing module 210a may suppress alert generation when the detected vehicle is identified as being part of the riding group. This suppression prevents unnecessary warnings that would otherwise be triggered by the legitimate presence of group members riding in expected positions. The suppression mechanism may be implemented through various means, such as flagging the detected vehicle as a known group member and bypassing alert generation logic, adjusting alert thresholds specifically for known group members to prevent triggering, or filtering out sensor data corresponding to known group member positions before processing for threat detection.

Fourth, the first processing module 210a may generate alerts only when the detected vehicle is confirmed as being outside the riding group. This confirmation may be based on the detected vehicle's position not matching any known group member positions within tolerance thresholds, the absence of a valid group member identifier in V2V communication from the detected vehicle, the detected vehicle's trajectory or speed being inconsistent with the riding group's movement patterns, or the detected vehicle approaching from a direction or at a rate that indicates it is not part of the coordinated group movement.

The false alert prevention mechanism may implement a confidence scoring system wherein each detected vehicle is assigned a confidence score indicating the likelihood that it is a group member. Alerts may be generated only when the confidence score falls below a predetermined threshold, indicating high confidence that the detected vehicle is outside the riding group. This approach provides robustness against edge cases where position data may be temporarily ambiguous due to GPS signal loss, sensor occlusion, or communication delays, for example.

The continuous monitoring and comparison process ensures that the system 200 maintains accurate awareness of group composition even as vehicles change positions within the formation, temporarily separate and rejoin the group, or experience variations in speed and trajectory.

According to an embodiment, the first processing module 210a is configured to implement a verification-based false alert filtering mechanism that adds an additional layer of confirmation before generating alerts, thereby further reducing the occurrence of false alerts caused by group members. This verification mechanism is particularly valuable in scenarios where initial threat detection may be ambiguous or where additional confirmation is warranted before alerting the driver and other group members.

The verification step may comprise performing at least one verification procedure to confirm that the detected vehicle is outside the riding group before generating the position-specific alert signal. According to an embodiment, the verification procedure may comprise one or more of the following verification methods:
a. V2V communication verification: as previously indicated, the first processing module 210a attempts to establish V2V communication with the detected vehicle to query its identity. If the detected vehicle responds with a valid group member identifier, the alert is suppressed. If no response is received or if the response indicates the vehicle is not a group member, the verification supports alert generation.
b. Position correlation verification: The first processing module 210a compares the detected vehicle's position with expected positions of group members based on the current formation pattern and recent movement history. If the detected vehicle's position corresponds to an expected group member position within tolerance thresholds, the alert is suppressed. If the position is inconsistent with any expected group member position, the verification supports alert generation.
c. Trajectory analysis verification: The first processing module 210a analyzes the trajectory of the detected vehicle over a time window (e.g., the previous 2 seconds, 5 seconds, or 10 seconds) to determine whether its movement pattern is consistent with the riding group's coordinated movement. If the trajectory indicates the detected vehicle has been traveling with the group in a consistent formation, the alert is suppressed. If the trajectory indicates the vehicle is approaching from outside the group or diverging from the group's movement pattern, the verification supports alert generation.
d. Multi-sensor confirmation verification: The first processing module 210a requires confirmation of the detected vehicle's presence and position from multiple sensors before generating an alert. For example, if a camera detects a vehicle in the blind spot but radar does not confirm the detection, the system 200 may suppress the alert pending additional verification. This multi-sensor approach reduces false alerts caused by sensor artifacts, reflections, or temporary occlusions.
e. Temporal persistence verification: The first processing module 210a requires that the detected vehicle remain in the alert-triggering position for a minimum duration (e.g., 0.5 seconds, 1 second, or 2 seconds) before generating an alert. This temporal filtering suppresses alerts for vehicles that briefly enter alert zones but quickly exit, such as vehicles passing through adjacent lanes or group members temporarily shifting positions within the formation.

According to an embodiment, the verification step may employ a multi-criteria decision process wherein multiple verification methods are applied simultaneously, and an alert is generated only when a majority of verification methods support alert generation, or when a weighted combination of verification results exceeds a predetermined threshold. This approach provides robustness and reduces the likelihood of false alerts while maintaining sensitivity to genuine threats. For example, if V2V communication verification indicates the detected vehicle is not a group member (supporting alert generation), position correlation verification is ambiguous due to GPS uncertainty (neutral), and trajectory analysis verification indicates the vehicle has been traveling with the group (opposing alert generation), the system 200 may assign weights to each verification method and calculate an overall verification score. If the score exceeds a threshold, the alert is generated; otherwise, it is suppressed pending additional verification.

According to an embodiment, the first processing module 210a can be configured to implement role-based alert filtering, wherein the alert filtering logic is dynamically adapted based on the current riding position of the first vehicle within the riding group. This role-based approach may recognize that different riding positions have different exposure profiles to potential threats and implements position-specific filtering rules to optimize alert relevance and minimize false alerts.

The role-based alert filtering comprises three primary filtering modes corresponding to the three main riding positions:
a. Leader position filtering: When the first vehicle has the leader position 11, the first processing module 210a may implement filtering logic specifically designed for the front-most vehicle in the riding group. In this mode, the first processing module 210a filters out forward proximity alerts caused by group members ahead. Since the leader vehicle is by definition at the front of the group, any vehicle detected ahead of the leader is necessarily outside the riding group (assuming proper group formation). However, in scenarios where group members may temporarily move ahead of the designated leader, such as during lane changes or passing maneuvers, the filtering logic identifies these group members through V2V communication or position correlation and suppresses alerts accordingly. The first processing module 210a may generate forward proximity alerts only for non-group vehicles ahead. These alerts can be useful for the leader vehicle as they provide warning of obstacles, slower-moving vehicles, oncoming traffic, or other hazards that the entire riding group will encounter. By filtering out false alerts caused by group members while maintaining sensitivity to genuine threats ahead, the system 200 ensures that the leader driver receives actionable information without unnecessary distractions. The leader position filtering may also implement enhanced sensitivity for forward proximity alerts, recognizing that the leader vehicle bears primary responsibility for detecting threats ahead and coordinating group response. For example, the predetermined forward distance threshold may be increased when the first vehicle occupies the leader position, providing earlier warning of potential hazards.
b. Member position filtering: When the first vehicle has the member position 12, the first processing module 210a may implement filtering logic designed for vehicles positioned between the leader and closer. In this mode, the first processing module 210a filters out blind spot alerts caused by group members riding in close proximity on left or right sides. This filtering is useful because member vehicles typically have other group members riding alongside them in staggered or side-by-side formations. The filtering logic identifies group members riding in close proximity through multiple verification methods, including V2V communication to confirm group membership, position correlation to verify that detected vehicles occupy expected positions within the group formation, and trajectory analysis to confirm that detected vehicles are moving consistently with the group's coordinated movement pattern. The first processing module 210a may generate blind spot alerts only for non-group vehicles on left or right sides. These alerts warn the driver of vehicles approaching from adjacent lanes, vehicles attempting to merge into the group's space, or other hazards on the sides that are not part of the coordinated riding group. By filtering out alerts caused by legitimate group members while maintaining awareness of external threats, the system 200 enables member vehicles to ride in close formation without constant alert distractions. The member position filtering may implement position-specific sensitivity adjustments. For example, if the first vehicle is riding on the left side of a staggered formation, the filtering logic may apply more aggressive filtering for blind spot alerts on the right side (where group members are expected) while maintaining higher sensitivity for blind spot alerts on the left side (where external threats are more likely).
c. Closer position filtering: When the first vehicle has the closer position 13, the first processing module 210a may implement filtering logic specifically designed for the rearmost vehicle in the riding group. In this mode, the first processing module 210a filters out rear proximity alerts caused by group members behind. Since the closer vehicle is by definition at the rear of the group, any vehicle detected behind the closer is necessarily outside the riding group (assuming proper group formation). The first processing module 210a may generate rear proximity alerts only for non-group vehicles behind. These alerts are useful for the closer vehicle as they provide warning of vehicles approaching from behind that may pose collision risks or require group coordination to accommodate. The closer vehicle serves as the sentinel for rear threats, and by filtering out false alerts while maintaining sensitivity to genuine approaching vehicles, the system 200 enables the closer driver to effectively monitor and communicate rear threats to the entire riding group. The closer position filtering may implement enhanced sensitivity for rear proximity alerts, recognizing that the closer vehicle bears primary responsibility for detecting threats from behind. For example, the predetermined rear distance threshold may be increased when the first vehicle occupies the closer position, providing earlier warning of approaching vehicles and allowing more time for group coordination.

The role-based alert filtering mechanism dynamically adapts as vehicles change positions within the riding group. For example, if the first vehicle transitions from a member position to the leader position (such as when the previous leader exits the group or falls back), the first processing module 210a automatically may switch from member position filtering to leader position filtering, adjusting alert sensitivity and filtering rules accordingly. This dynamic adaptation is accomplished through continuous monitoring of the first vehicle's position relative to other group members and automatic reconfiguration of filtering parameters when position changes are detected.

According to an embodiment, the role-based filtering may be further refined based on the specific formation pattern of the riding group. For example, in a single-file formation, member vehicles may have different filtering rules than in a staggered formation. The first processing module 210a may receive formation pattern information from the leader vehicle or determine the formation pattern through analysis of group member positions, and adjust filtering rules accordingly to optimize alert relevance for the specific riding configuration.

According to another embodiment, a vehicle of a riding group, for example, can be configured to use V2V or V2X communication and GPS to receive coordinates from N vehicles within its range. It then sorts the most threatening vehicles based on their time-to-impact (TTI), calculated by dividing relative distance by relative speed. The vehicle employs for example a Kalman filter approach to calculate trajectories, using for example available sensors such as camera, radar, lidar, GPS, IMU, steering, throttle, and brake data.

According to an embodiment, the method can comprise the following steps:
The vehicle equipped with V2V or V2X communication and GPS receives coordinates from other vehicles within its communication range.
The vehicle sorts the N most threatening vehicles based on their relative distance divided by their relative speed (time-to-impact=TTI).
A Kalman filter approach is used to calculate the trajectories of the sorted vehicles, taking into account the precision provided by available sensors.
The minimum distance between the calculated trajectories is determined with maximum precision according to the relative speeds of the vehicles.

According to an embodiment, the system 200 implements a comprehensive position determination and communication mechanism that enables each vehicle in the riding group to maintain awareness of other vehicles' positions and to communicate this positional information to drivers.

The first processing module 210a can be configured to determine a vehicle position of the second vehicle within the riding group and to communicate the vehicle position of the second vehicle to the first driver. Similarly, the second processing module 210b can be configured to determine a vehicle position of the first vehicle within the riding group and to communicate the vehicle position of the first vehicle to the second driver. This bidirectional position awareness enables each driver to maintain situational awareness of other group members' locations, facilitating coordinated maneuvering and formation maintenance.

The determination of vehicle positions can be accomplished using at least one triangulation method based on multiple data sources. According to an embodiment, the triangulation method may utilize one or more of the following data sources:
a. GPS sensor data: Each vehicle in the riding group is equipped with GPS sensors that provide absolute position coordinates (latitude, longitude, and optionally altitude). The processing modules 210 may receive GPS data from their respective vehicles and from other vehicles in the riding group via V2V or V2X communication, for example. By comparing GPS coordinates, each processing module 210 can determine the relative positions of other vehicles with respect to its own vehicle. For example, the first processing module 210a receives GPS coordinates from the second vehicle via the communication module 230b, compares these coordinates with the first vehicle's GPS coordinates, and calculates the relative position (distance, bearing, and relative elevation) of the second vehicle. The GPS-based position determination may implement error correction and filtering techniques to account for GPS accuracy limitations, such as Kalman filtering to smooth position estimates and reduce noise, differential GPS techniques to improve absolute accuracy, or multi-epoch averaging to reduce instantaneous position errors.
b. Sensor information inferred from cameras, radar, Lidar, or other sensing devices: Each vehicle's set of sensors 220 comprises perception-based sensors such as cameras, radar, lidar, and ultrasonic sensors that detect objects in the vehicle's surroundings. The processing modules 210 may analyze sensor data to identify other vehicles and determine their positions relative to the sensing vehicle. For example, the first processing module 210a processes camera images to detect the second vehicle, estimates the distance to the second vehicle using stereo vision or monocular depth estimation techniques, and determines the bearing to the second vehicle based on its position within the camera's field of view. Radar and lidar sensors can provide direct distance and bearing measurements to detected objects, enabling precise relative position determination. The processing modules 210 may implement object recognition algorithms to identify which detected objects correspond to group member vehicles, using features such as vehicle size, shape, reflectivity characteristics, or distinctive markings. The sensor-based position determination may fuse data from multiple sensor types to improve accuracy and robustness. For example, camera-based position estimates may be combined with radar-based distance measurements to provide more accurate relative position information than either sensor could provide independently.
c. V2V Communication: Vehicles in the riding group may exchange position information directly through V2V communication protocols. Each vehicle broadcasts its current position, velocity, heading, and other relevant state information, which is received by other vehicles in communication range. The processing modules 210 may use this exchanged information to maintain awareness of other group members' positions without relying solely on sensor detection. V2V communication provides several advantages for position determination, including the ability to maintain position awareness even when vehicles are not within direct sensor range (such as when vehicles are around curves or over hills), reduced latency compared to sensor-based detection and recognition, and the ability to exchange additional contextual information such as intended maneuvers or formation positions. The V2V communication may implement secure authentication protocols to ensure that position information is received only from legitimate group members and to prevent spoofing or unauthorized access to group communications.
d. V2X Communication: In addition to direct V2V communication, vehicles may utilize V2X communication to exchange position information through infrastructure-based systems. For example, vehicles may communicate through roadside units, cellular networks, or other communication infrastructure. V2X communication can extend the range and reliability of position information exchange, particularly in scenarios where direct V2V communication may be limited by terrain, obstacles, or communication range constraints.

The triangulation method may combine information from multiple data sources to determine vehicle positions with enhanced accuracy and reliability. For example, the first processing module 210a may receive GPS coordinates from the second vehicle via V2V communication, detect the second vehicle using cameras and radar, and combine these multiple position estimates using sensor fusion techniques such as Kalman filtering, particle filtering, or Bayesian estimation to produce a refined position estimate that is more accurate than any single data source could provide.

The triangulation method may implement confidence scoring wherein each position estimate is assigned a confidence value based on the quality and reliability of the underlying data sources. Position estimates with higher confidence values can be weighted more heavily in the fusion process, while estimates with lower confidence values (such as those based on degraded GPS signals or ambiguous sensor detections) can be weighted less heavily or discarded.

According to an embodiment, the communication of vehicle positions to drivers is accomplished through the user interface 260. According to an embodiment, the user interface 260 may display vehicle positions using various visualization methods, including a top-down map view showing the positions of all group members relative to the user's vehicle, graphical icons representing each vehicle positioned according to their relative locations, numerical displays showing distances and bearings to other group members, or augmented reality overlays that superimpose position indicators onto camera views of the surrounding environment, for example. The user interface 260 may display an information window showing the riding positions of all group members, with the first driver's vehicle highlighted and other vehicles shown in their relative positions. The display may update in real-time as vehicles move, providing continuous situational awareness to the driver. The position communication may be supplemented with additional contextual information, such as the designated riding position (leader, member, closer) of each vehicle, the distance between vehicles, alerts or warnings associated with specific vehicles, or indicators of communication quality or position estimate confidence.

According to an example, and as illustrated by FIG. 2, in a multi-lane context, the following potential alerts, causes and display rules can be observed:

| | | | | Displayed on other |
|---|---|---|---|---|
| Group | | | | vehicles of the riding |
| Member | Position | Potential alert | Cause | group? |
| A | Leader | Forward collision | V1 | Yes |
| | 11 | warning | | |
| | | Blind spot alert | B | No |
| | | (right) | | |
| B | Member | Blind spot alert | V4 | Yes |
| | 12 | (right) | | |
| | (right) | Blind spot | C | No |
| | | alert (left) | | |
| C | Member | Blind spot | V2 | Yes |
| | 12 | alert (left) | | |
| | (left) | Blind spot alert | D | No |
| | | (right) | | |
| D | Closer | Rear collision | V3 | Yes |
| | 13 | warning | | |

According to an example, and as illustrated by FIG. 3, in an offroad context, encountering other vehicles coming from any direction, the following potential alerts, causes and display rules can be observed:

| | | | | Displayed on other |
|---|---|---|---|---|
| Group | | | | vehicles of the riding |
| Member | Position | Potential alert | Cause | group? |
| A | Leader | Oncoming vehicle | V1 | Yes |
| | 11 | that should keep left | | |
| B | Member | n/a | | |
| | 12 | | | |
| C | Member | n/a | | |
| | 12 | | | |
| D | Closer | Rear collision | V2 | Yes |
| | 13 | warning | | |

According to an embodiment, and as illustrated by FIGS. 13 and 1, a first vehicle's processing module 210a is responsible for monitoring sensor signals from its onboard set of sensors to detect potential threats in its surrounding environment. Upon detection, it generates n alert signal based on the threat or obstacle and sends this notification wirelessly to other processing modules 210 associated with vehicles in the riding group. Each other processing module 210 receives the alert signal and generates a corresponding warning for the user of its vehicle.

The system 200 can be configured to detect various types of threats, such as obstacles, other vehicles, or weather conditions. The alert signals generated by the vehicle's processing module 210 can be customized based on the type of threat detected, allowing users to receive relevant and actionable information in real-time.

This system 200 enhances safety and coordination during rides while also providing additional features to improve the overall user experience. The system 200 can be customized based on user preferences and integrated with external services to offer a more comprehensive solution for managing communications between vehicles in a riding group.

For instance, if a hazard is detected by one vehicle, it can broadcast this information to all other vehicles in the group, allowing them to take evasive action accordingly.

According to an embodiment, each processing module 210 is configured to provide emergency response capabilities.

More specifically, according to this embodiment, each communication module 230 enables users to send alerts to other group members and emergency services in case of an emergency. For example, the communication module 230 can utilize a reliable and secure communication protocol to ensure timely and accurate transmission of emergency messages.

Additionally, each processing module 210 may incorporate location tracking technology. This feature allows emergency responders to quickly identify and locate the source of the emergency alert. This information can be transmitted in real-time to emergency services for efficient response planning.

Furthermore, some embodiments may comprise a user interface that simplifies the process of sending emergency alerts. For example, this interface is intuitive and easy to use, even during stressful or time-critical situations.

In case of network connectivity issues, certain embodiments may employ offline storage and transmission capabilities. This feature ensures that emergency alerts can still be sent even when the system 200 is unable to establish a reliable connection with external communication modules.

Finally, some embodiments may incorporate data encryption and access control mechanisms to protect user privacy and ensure the confidentiality of emergency communications. These security features help maintain the integrity and reliability of the emergency response system.

According to an embodiment and as illustrated by FIG. 1a, the present technology relates to a computer product program for managing a riding group which, when executed by at least one processing unit 210, executes the method according to the present technology. For example, the present technology can also relate to a non-volatile memory 270 comprising at least the computer program product. The non-volatile memory 270 can be a Solid State Disk (SSD), for example.

Modifications and improvements to the above-described implementations of the present technology may become apparent to those skilled in the art. The foregoing description is intended to be exemplary rather than limiting. The scope of the present technology is, therefore, intended to be limited solely by the scope of the appended claims.

1. A system for managing a removal of a vehicle from a riding group comprising a plurality of vehicles riding together, the system comprising:
one processing module associated with each vehicle of the riding group,
one set of sensors integrated into each vehicle of the riding group; each set of sensors being configured to sense an environment surrounding a corresponding vehicle of the riding group; and
one communication module integrated into each vehicle of the riding group and configured to enable the processing modules to communicate with one another directly or via at least one server,
each of the processing modules being configured to:
manage group fracturing in response to a given vehicle of the plurality of vehicles exiting the riding group by:
identifying members of the riding group; and
removing a given vehicle from the riding group in response to a predetermined condition being met.

2. The system according to claim 1, wherein the predetermined condition comprises at least one of:
receiving, by at least one of the processing modules, a notification from the given vehicle, the notification being generated by the processing module of the given vehicle in response to a command of a driver of the given vehicle;
losing, by at least one of the processing modules, a direct connection to the given vehicle in response to the given vehicle being overtaken by another vehicle outside of the riding group; or
detecting the given vehicle at a distance from at least one of the vehicles of the riding group greater than a predetermined threshold.

3. The system according to claim 1, wherein each of the processing modules is configured to:
monitor at least one of:
distances between each vehicle of the riding group using sensor data from a corresponding set of sensors; or
distances between each vehicle in the riding group with respect to an average position of the riding group; and
display a warning message to a driver of the given vehicle in response to the distance of the given vehicle to a vehicle of the riding group being greater than a first threshold, the first threshold being lower than the predetermined threshold.

4. The system according to claim 3, wherein the monitored distances between each vehicle in the riding group with respect to the average position of the riding group are monitored along at least one of a riding path or perpendicular to a riding path and each of the processing modules is configured to temporarily split the riding group in response to the given vehicle being disposed at a distance between the first threshold and the predetermined threshold.

5. The system according to claim 2, wherein a command from a driver of a given vehicle is at least one of a push of a button or a vocal command, wherein a processing module of the given vehicle is configured to request confirmation from the driver that the driver wants to leave the riding group, and wherein the confirmation from the driver serves as the command indicating the driver's intent to leave the riding group.

6. The system according to claim 1, wherein each of the sets of sensors is configured to detect another vehicle outside of the riding group and wherein each of the processing modules is configured to generate a majority sub-group and a minority sub-group in response to the detection of another vehicle being outside the riding group and taking a position between two vehicles of the riding group, the majority sub-group comprising a number of vehicles of the riding group higher than the number of vehicles of the riding group comprised by the minority sub-group, the majority sub-group and the minority sub-group being on opposite sides of the another vehicle.

7. The system according to claim 1, wherein each of the sets of sensors comprises a perception-based sensor, and wherein each of the processing modules is configured to use a pre-trained neural network in cooperation with the perception-based sensor to identify the vehicles of the riding group.

8. A system for managing an addition of a vehicle to a riding group comprising a plurality of vehicles riding together, the system comprising:
one processing module associated with each vehicle of the riding group;
one set of sensors integrated into each vehicle of the riding group and each set of sensors being configured to sense an environment surrounding a corresponding vehicle of the riding group; and
one communication module integrated into each vehicle of the riding group and configured to enable the processing modules to communicate with one another directly or via at least one server; and
wherein the processing module is configured to:
manage group forming in response to a rider joining or rejoining the riding group by:
identifying members of the riding group;
identifying a new vehicle that is not a member of the riding group;
determining whether the new vehicle is allowed to join or rejoin the riding group based on at least one predetermined criterion;
adding the new vehicle to the riding group in response to the new vehicle meeting the at least one predetermined criterion; and
notifying at least one vehicle of the riding group of the new vehicle being added to the riding group.

9. The system according to claim 8, wherein each of the sets of sensors comprises a perception-based sensor, and wherein each of the processing modules is configured to use a perception-based sensor and a pre-trained neural network in cooperation with a perception-based sensor to identify the vehicles of the riding group and the new vehicle.

10. The system according to claim 8, wherein each of the processing modules is configured to identify the new vehicle in response to the new vehicle entering a predetermined range of the riding group wherein the new vehicle being at a distance from a processing module of a vehicle of the riding group smaller than a predetermined distance.

11. The system according to claim 8, wherein each of the processing modules is configured to identify the new vehicle in response to the new vehicle being within a predetermined distance for at least a predetermined amount of time from at least one of the processing modules of at least one of the vehicles of the riding group.

12. The system according to claim 8, wherein, in response to identifying the new vehicle, each of the processing modules is configured to determine if the new vehicle is a former vehicle of the riding group based on the at least one of the received identification number, user profile or vehicle profile.

13. The system according to claim 8, wherein each of the processing modules is configured to receive at least one of an identification number, a user profile, or a vehicle profile from the new vehicle and wherein each of the processing modules is configured to determine if the new vehicle is allowed to join or rejoin the riding group based on the at least one of the received identification number, user profile, or vehicle profile and wherein the processing module is configured to verify that the at least one of the received identification number, user profile, or vehicle profile is registered in at least one of a predetermined list of identification numbers, a predetermined list of user profiles, or a predetermined list of vehicle profiles allowed to participate in the riding group.

14. The system according to claim 8, wherein the at least one predetermined criterion comprises at least one of:
an identification number associated with the new vehicle being registered in a predetermined list of identification numbers allowed to participate in the riding group;
a user profile associated with the new vehicle being registered in a predetermined list of user profiles allowed to participate in the riding group;
a group profile associated with the new vehicle being registered in a predetermined list of group profiles allowed to participate in the riding group; or
a vehicle profile associated with the new vehicle being registered in a predetermined list of vehicle profiles allowed to participate in the riding group.

15. A method for managing membership of a riding group comprising a plurality of vehicles riding together, each vehicle of the riding group being associated with a processing module, each vehicle of the riding group comprising a set of sensors and a communication module, the method comprising managing group membership by:
identifying members of the riding group;
monitoring at least one removal condition associated with a given vehicle of the riding group;
removing the given vehicle from the riding group in response to the at least one removal condition being met;
identifying a new vehicle that is not a member of the riding group;
determining whether the new vehicle is allowed to join or rejoin the riding group based on at least one predetermined criterion;
adding the new vehicle to the riding group in response to the new vehicle meeting the at least one predetermined criterion; and
notifying at least one vehicle of the riding group of changes in group membership.

16. The method according to claim 15, wherein a command from a driver of a given vehicle is at least one of a push of a button or a vocal command, wherein a processing module of the given vehicle is configured to request confirmation from the driver that the driver wants to leave the riding group, and wherein the confirmation from the driver serves as the command indicating the driver's intent to leave the riding group.

17. The method according to claim 15, comprising detecting another vehicle outside of the riding group and generating a majority sub-group and a minority sub-group in response to the detection of another vehicle not being part of the riding group and taking a position between two vehicles of the riding group, the majority sub-group comprising a number of vehicles of the riding group higher than the number of vehicles of the riding group comprised by the minority sub-group, the majority sub-group and the minority sub-group being on opposite sides of the another vehicle.

18. The method according to claim 15, wherein the new vehicle comprises a processing module and wherein the method comprises verifying by the processing module of the new vehicle that at least one of the received identification number, the received user profile, the received group profile or the received vehicle profile is registered in at least one of a predetermined list of identification numbers, a predetermined list of user profiles, a predetermined list of group profiles or a predetermined list of vehicle profiles, and wherein the at least one predetermined criterion comprises at least one of:
an identification number associated with the new vehicle being registered in a predetermined list of identification numbers allowed to participate in the riding group;
a user profile associated with the new vehicle being registered in a predetermined list of profiles allowed to participate in the riding group;
a group profile associated with the new vehicle being registered in a predetermined list of profiles allowed to participate in the riding group; or
a vehicle profile associated with the new vehicle being registered in a predetermined list of profiles allowed to participate in the riding group; and
wherein the method further comprises adding the position of the new vehicle in the riding group in response to adding the new vehicle to the riding group;
adding the new vehicle to the riding group in response to a validation by a driver of the new vehicle of a request to join or rejoin the riding group; and
Wherein each of the processing modules comprises a display device, and wherein the method comprises providing at least one of information, notification, or warning to one or more users of each vehicle of the riding group and to receive user input.

19. A computer product program for managing membership a riding group which, when executed by at least one processing unit, executes the method according to claim 15.

20. A non-volatile memory comprising at least one computer program product according to claim 19.
